(19) United States
(12) Patent Application Publication
(10) Pub. No.: US 2018/0234550 A1
(43) Pub. Date: Aug. 16, 2018

(54) CLOUD COMPUTING TELECOMMUNICATIONS PLATFORM

(71) Applicant: 2402326 ONTARIO INC. O/A NUAGE TELECOM INC., Toronto (CA)

(72) Inventors: David LIFSON, Toronto (CA); Eric LIFSON, Toronto (CA); Stefan FABRY, Toronto (CA); Ivan VUJISIC, Toronto (CA)

(21) Appl. No.: 15/531,407

(22) PCT Filed: Mar. 14, 2016
(86) PCT No.: PCT/CA2016/000071

§ 371 Date: May 26, 2017

Related U.S. Application Data
(60) Provisional application No. 62/132,036, filed on Mar. 12, 2015.

(51) Int. Cl. H04M 7/00; H04L 29/06; H04L 29/08; H04W 12/06; H04L 9/32

(52) U.S. Cl. CPC H04M 7/006; H04L 67/42; H04L 65/1069; H04L 9/3215; H04L 65/1006; H04L 67/1097; H04W 12/06; H04L 65/403

(57) ABSTRACT

A cloud based telecommunication system with different communication session services including call transfer, voice mail, call routing, conference call, Smart Hold, call recording, screen sharing, real-time, delayed and post conversation call keyword performance analytics, caller disposition analysis, real-time language translation, video calling, automated call answering, context sensitive on-hold messaging, no interruption move call from one device to another, and so on.

### FIELD

The improvements generally relate to the field of telecommunications systems. In particular, the improvements generally relate to the field of cloud computing based telecommunications systems.

### BACKGROUND

Traditional telecommunications systems are based on a public switched telephone network (PSTN) of wires (e.g. copper wires), cables (e.g. fiber optic cables) and switches that provide the global phone network. Cloud computing based telecommunications systems use the Internet for at least a portion of the network used for the call connection. Voice over internet protocol (VoIP) is the technology protocol used to transmit telephone voice and video data over the Internet. Business communications systems may provide various fragmented telephony services. There exists a need for improved consolidated cloud computing based telecommunications systems for business or other communication connection services, or at least alternatives. There exists a need for a cohesive telecommunications platform integrating various features in a comprehensive cloud based system.

### SUMMARY

In accordance with one aspect, there is provided a cloud based telecommunications system with a telecommunications switching platform.

A cloud computing telecommunications switch device connects seamlessly and in real-time to multiple client devices of different types and formats to establish the communication session connection and data packet exchange. The data packets may be voice, video, messaging, screen broadcasting, conferencing, video/voice, and so on.

The cloud based telecommunications system may have a telecommunications server platform for cloud based distributed communication session processing with a real time two-way socket data stream connection between the telecommunications server platform and client devices to establish the communication session connection and data packet exchange.

The cloud based telecommunications system may have a telecommunications server platform with a Live Call Communicator (LCC) interface that provides real-time communication session display monitoring and two-way interaction with a manager client device.

The cloud based telecommunications server platform may configure a cloud based Move Call application that seamlessly moves a communication session connection from one device to another device without interrupting the communication session in progress.

A cloud based telecommunications switching platform configures a Smart Hold application for selection of on-hold messaging to be dynamically and automatically selected and delivered to a client device based upon communication session related data.

The cloud based telecommunications switching platform may process communication session related data such as, for example, caller ID number, dialed number, preferences, session initiation protocol (SIP) address that they are calling from, or other call related data.

A cloud based telecommunications switching platform configuring a traffic management application that controls routing of communication session connection data packets over network hardware components and between communication session (voice, video, messaging) devices using dynamic input and routing criteria.

In another aspect, there is provided a network controller for a cloud based telecommunications system.

A processor detects a request for a call connection between communication session devices using a plurality of geographically diverse telecommunications servers and network infrastructure. In response, the processor determines a distribution across the plurality of geographically diverse telecommunications servers for the call connection between the plurality of disparate devices.

Routing hardware establishes a communication session connection between the plurality of disparate devices using the distribution across the plurality of geographically diverse telecommunications servers.

A cloud based telecommunications system may have a telecommunications server platform for cloud based distributed communication session processing with a transfer application coupled to a graphical user interface for display on a display device. The transfer application transfers a communications session connection to at least one other call device using the telecommunications server platform in response to detecting a transfer action at the graphical user interface.

A cloud based telecommunications system has a telecommunications server platform for cloud based distributed communications sessions processing with a conference application coupled to a graphical user interface for display on a display device. The conference application establishes a conference communications session connection between disparate devices using the telecommunications server platform in response to detecting a single action at the graphical user interface.

A cloud based telecommunications system has a telecommunications server platform for cloud based distributed communications session processing with a security application for securing a communication session connection to at least one other call device using the telecommunications server platform with a secondary level of authentication.

A cloud based telecommunications system has a telecommunications server platform for cloud based distributed communications session processing, a data storage server with voice mail files, and configures a security application for securing the voice mail files using a slicing and scrambling process.

A cloud based telecommunications system has telecommunications server platform for cloud based distributed communications session processing, a data storage server with voice mail files, and configures an NLP application for processing the voice mail files to trigger external actions.

A cloud based telecommunications system has a telecommunications server platform for cloud based distributed communication session processing, and an NLP application for processing data files for a communications session in progress to trigger external actions.

A cloud based telecommunications system may have different combinations of components described herein.

In another aspect, embodiments may also be directed to processes and products using hardware components for the cloud based telecommunications system.

Many further features and combinations thereof concerning embodiments described herein will appear to those skilled in the art following a reading of the instant disclosure.

### DESCRIPTION OF THE FIGURES

In the figures,

FIG. 1 is a schematic diagram of a server platform and extension device interconnections according to some embodiments;

FIG. 2 is a schematic diagram of a server processor according to some embodiments;

FIG. 3 is a schematic diagram of a server platform for cloud based telecommunications services with a Live Communications Link (LCL) according to some embodiments;

FIG. 4 is a schematic diagram of another server platform for cloud based telecommunications services including a Live Call Communications Layer (LCC) according to some embodiments;

FIG. 5 is a schematic diagram of a Buffer Data Duplication Layer according to some embodiments;

FIG. 6 is a schematic diagram of another server platform for cloud based telecommunications services with a Smart Hold application according to some embodiments;

FIG. 7 is a schematic diagram of a server platform for cloud based telecommunications services including a Smart Hold application according to some embodiments;

FIG. 8 is a schematic diagram of a server platform for cloud based telecommunications services with a traffic management application according to some embodiments;

FIG. 9 is a schematic diagram of Distributed Network Processing according to some embodiments;

FIG. 10 is a schematic diagram of a server platform for cloud based telecommunications services with a transfer application according to some embodiments;

FIGS. 11 to 14 are screen shots of user interfaces according to some embodiments;

FIG. 15 is a schematic diagram of a server platform for cloud based telecommunications services with a conference application according to some embodiments;

FIG. 16 is a schematic diagram of a server platform for cloud based telecommunications services with an NLP analysis engine according to some embodiments;

FIG. 17 is a flow diagram of process for cloud based telecommunication services with NLP analysis according to some embodiments;

FIG. 18 is a schematic diagram of a server platform for cloud based telecommunications services with communication phrase detection according to some embodiments;

FIG. 19 is a schematic diagram of a secure connection according to some embodiments;

FIG. 20 is a schematic diagram of a server platform for cloud based telecommunications services with secure voice mail according to some embodiments;

FIG. 21 is a schematic diagram of another server platform for cloud based telecommunications services according to some embodiments; and

FIGS. 22 to 29 are screen shots of user interfaces according to some embodiments.

### DETAILED DESCRIPTION

Embodiments described herein relate to cloud computing telecommunications networks and systems. Embodiments described herein may provide cloud computing based telecommunications services using a server platform. The server platform provides telecommunications and other forms of electronic messaging services using the Internet for at least a portion of the network used for the call or other communications session connection, and may also use other networks, such as PSTN, cellular, and so on, for other portions of the call connection. Telecommunications server platform implements VoIP technology to transmit voice data and provide business telecommunications services including call transfer, voice mail, call routing, conference call, Smart Hold, call recording, screen sharing, real-time, delayed and post conversation call keyword performance analytics, caller disposition analysis, real-time language translation, video calling, automated call answering, context sensitive on-hold messaging, no interruption move call from one device to another, and so on.

Device Connection

Embodiments described herein relate to cloud computing telecommunications systems where a server platform connects to different client devices to provide cloud-based telecommunications services.

Device Independent Extension

In accordance with an aspect, embodiments described herein relate to a telecommunications switching platform and a cloud computing telecommunications switch device that connects seamlessly and in real-time to multiple devices of disparate types and formats.

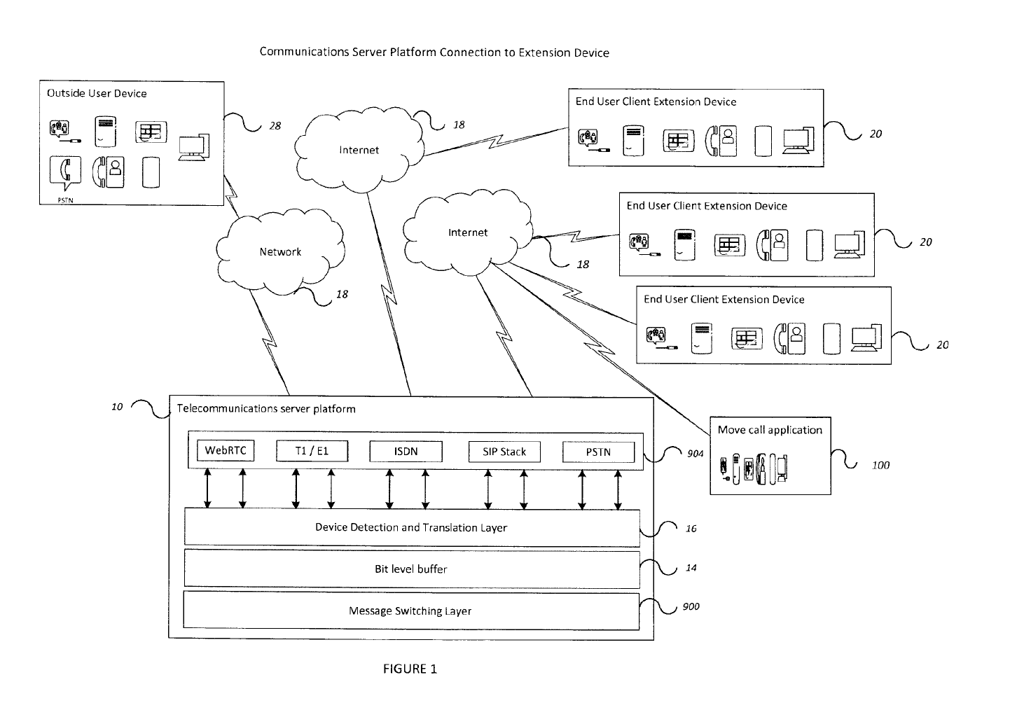

FIG. 1 shows an example of telecommunications server platform 10 and extension device 20 with physical interconnections, according to some embodiments. Telecommunications server platform 10 and extension device(s) 20 provide the ability to use a variety of different client devices 28 in conjunction with a cloud-based telecommunications service. Server platform 10 and extension devices 20 provide a secure connection via a two factor authentication process to “party on call” or outside user devices 28 across disparate standards, protocols, types and formats for devices.

Server platform 10 provides a cloud computing telecommunications system where telecommunications devices, switches, and data storage are accessed over networks 18 with Internet based network infrastructure. Telecommunications server platform 10 provides telecommunications or telephony voice services by replacing conventional business telecommunications equipment (such as a PBX for example) with voice over Internet Protocol (VoIP) infrastructure.

Telecommunications server platform 10 handles voice, video, messaging, and other connections between device(s) 20 and outside user connected devices 28. Telecommunications server platform 10 connects to outside user connected devices 28 through network 18 in a cloud computing configuration. Server platform 10 connects through network 18 to extension device 20 in a cloud computing or other configuration, and outside user devices 28. Although only one outside user device 28 is shown for simplicity there may be multiple outside user devices 28 connected to one or more extension devices 20. A logical connection is established where the device protocol is detected (via device detection and translation layer 16) by the telecommunications server platform 10 and translated in real-time.

Extension device 20 is a given format end-user device. An extension device 20 is a physical computing device with hardware and software components, including a desktop SIP phone, mobile device, tablet device, fax device, multimedia device, video device, or other communications or telepresence device. Extension device 20 registers multiple devices of various formats, types and standards simultaneously to a single user. This enables a user to have multiple types of communication devices registered to a single logical extension. Extension device 20 enables a user to register several devices 20 regardless of device format and type to a single logical extension. Extension device 20 supports multiple device types to allow transparency and connectivity between one device type and another device type. Device independence permits a user to use disparate devices 28 (e.g. a smartphone, desktop, fax, video, messaging client, software client, tablet, and so on) all on the same logical extension. Registration may be restricted to allowed devices using a two factor authorization process to ensure identity of the connected device and the security of the data.

Extension device 20 aggregates different types of devices 20 for a user to maximize client device features and capabilities. Extension device 20 provides a device appropriate rich user experience that a user can seamlessly aggregate features and capabilities from multiple devices 20. Telecommunications server platform 10 connects to different devices 20 via the same user extension device 20 so that the user can use different devices 20 for different purposes with multiple external client devices 28.

As an illustrative example, telecommunications server platform 10 may allow a user to work remotely from an office where extension device 20 and telecommunications server platform 10 connects to a variety of devices 20, 28 in a secure fashion. A user can use different devices 20 for their remote office or for other communications needs. For example, and without limitation, device 20 may be a server, network appliance, set-top box, embedded device, computer expansion module, telepresence terminal, personal computer, laptop, personal data assistant, cellular device, mobile device, paging device, messaging client, multimedia device, communications device, smartphone device, UMPC tablet, video display terminal, gaming console, electronic reading device, and wireless hypermedia device or any other computing device.

Telecommunications server platform 10 provides a cloud based communications switching environment. Telecommunications server platform 10 and extension device 20 seamlessly move a call or communications session (voice, video, data messaging, and so on) in progress with user device 28 from one extension device 20 to another device 20 of disparate or different types and formats.

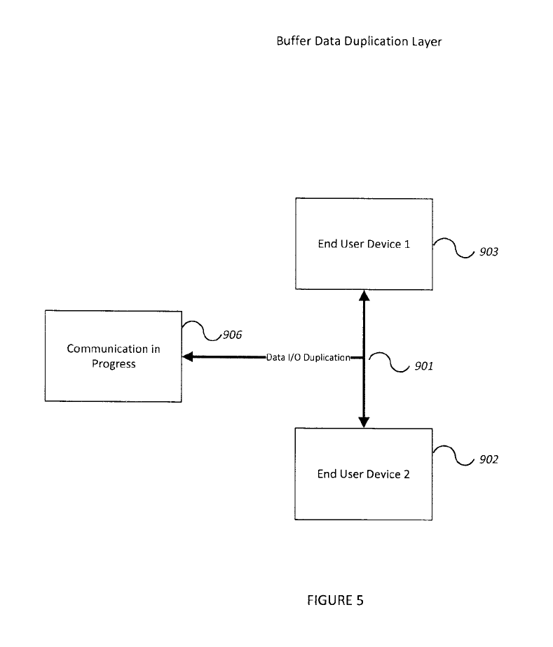

Telecommunications server platform 10 includes an asynchronous data (bit level) buffer 14, which is shown in further detail in FIG. 5. The asynchronous data (bit level) buffer 14 duplicates the data stream 901 to two devices 20 simultaneously. When the call session is transferred or moved from one device 20 to another device 20 the second data stream 903 is disconnected after the relevant data transfer is detected on the device 20 of the second data stream 902. As the second device stream 902 is enabled, automatic gain control (AGC) is applied to even match any audio volume discrepancies in the levels. Continuing to transmit the data stream on the first device 20 provides a seamless transfer that cannot be audibly perceived by the other connected party at user device 28.

Telecommunications server platform 10 and extension device 20 move the call or communications session without the other party at device 28 audibly perceiving that the call or communications session was moved to another device 20 to a plurality disparate standard. A call as used herein may refer to different communications sessions, including voice, video, data messaging, and so on.

For simplicity only one telecommunications server platform 10 is shown but system may include more telecommunications server platforms 10 in a redundant or similar configuration. Similarly, for simplicity only the system may include one or more extension devices 20, and connect to one or more external end user devices 28.

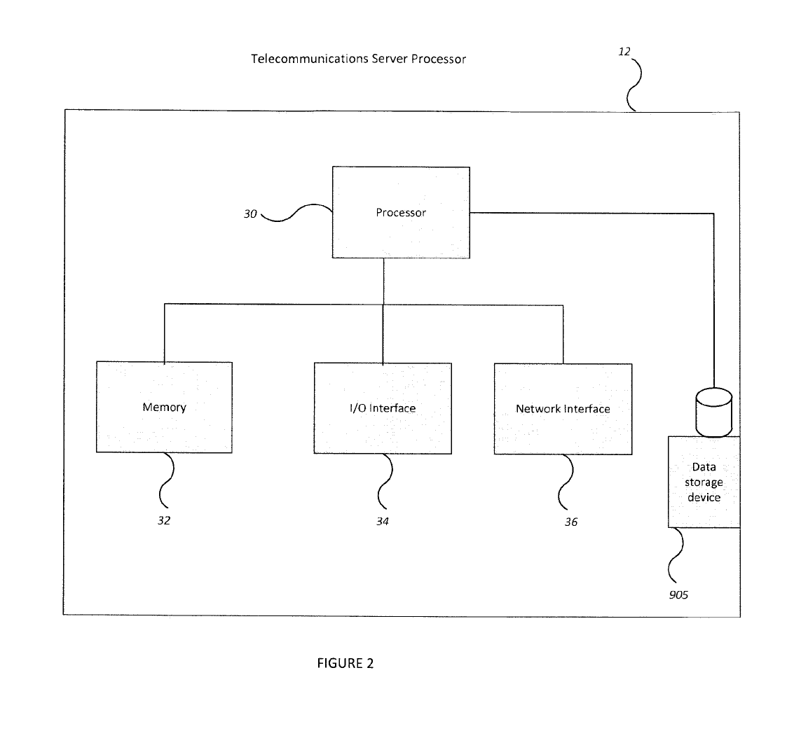

Telecommunications server platform 10 includes a server processor 12 (FIG. 2), a bit level buffer device 14 (FIG. 5), a detection and translation device 16, and a Message Switching layer 900. The detection and translation device 16 determines the protocol of an incoming message and translates it in real time to communicate with another device 20, 28 of a disparate protocol. Telecommunications server platform 10 includes a protocol interface 904 to communicate and translate between protocols (e.g. WebRTC, T1/E1, ISDN, SIP Stack, PSTN etc.). This includes echo cancellation for PSTN and other communications protocols as necessary.

FIG. 2 is a schematic diagram of server processor 12, exemplary of an embodiment. Telecommunications server platform 10 uses server processor 12 to provide telecommunications applications and services in a cloud based or other configuration. These applications include message switching, conferencing bridges, chat, video calling, fax, voice, messaging, screen sharing, etc.

The server processor 12 includes at least one processor 30, memory 32 and/or data storage device 905 (including volatile memory or non-volatile memory or other data storage elements or a combination thereof), and at least one communication interface (e.g. I/O interface 34 network interface 36). The server processor 12 components may be connected in various ways including directly coupled, indirectly coupled via a network, and distributed over a wide geographic area and connected via a network (which may be referred to as cloud computing).

Each processor 30 may be, for example, a microprocessor or microcontroller, a digital signal processing (DSP) processor, an integrated circuit, a field programmable gate array (FPGA), a reconfigurable processor, a programmable read-only memory (PROM), or any combination thereof.

Memory 32 or data storage device 905 may include a suitable combination of any type of computer memory that is located either internally or externally such as, for example, random-access memory (RAM), read-only memory (ROM), compact disc read-only memory (CDROM), non-volatile (NVRAM), electro-optical memory, magneto-optical memory, erasable programmable read-only memory (EPROM), and electrically-erasable programmable read-only memory (EEPROM), Ferroelectric RAM (FRAM) or the like.

Each I/O interface 34 enables server processor 12 to interconnect with one or more input devices, such as a keyboard, mouse, camera, touch screen and a microphone, or with one or more output devices such as a display screen and a speaker.

Each network interface 36 enables server processor 12 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, T1/E1, satellite, mobile, wireless (e.g. Wi-Fi, WiMAX), SS7 signaling network, fixed line, local area network, wide area network, and others, including any combination of these.

Telecommunications server platform 10 is operable to register and authenticate users (using a login, unique identifier, and password for example) prior to providing access to telecommunications applications, network resources, other networks and network security devices.

Telecommunications server platform 10 includes a full duplex buffer device 14 to buffer a handoff amongst various devices 20 that are registered to an extension device 20 in the cloud based telecommunications switching environment. The buffer device 14 (FIG. 5) buffers both the transmit and the receive bits to give the illusion of seamless communications on top of a protocol one-to-one server side translation layer. The asynchronous data buffer 901 duplicates the data stream to two devices simultaneously. When the call communication 906 is transferred or moved from one device to another the second stream is disconnected after relevant data transfer is detected on the End User Device of the second stream 902. As the second device stream 902 is enabled, automatic gain control is applied to even the audio levels. Continuing to transmit the stream on the first device 903 ensures a seamless transfer of the communication 906 that cannot be perceived by the other connected party 28.

Telecommunications switching platform 10 provides this buffering capability in a cloud based telecommunications switching environment.

Live Communications Layer (LCL)

In accordance with an aspect, embodiments described herein relate to a server platform for cloud based distributed voice, video, messaging and other communications processing with real time two-way socket data stream connection to client devices.

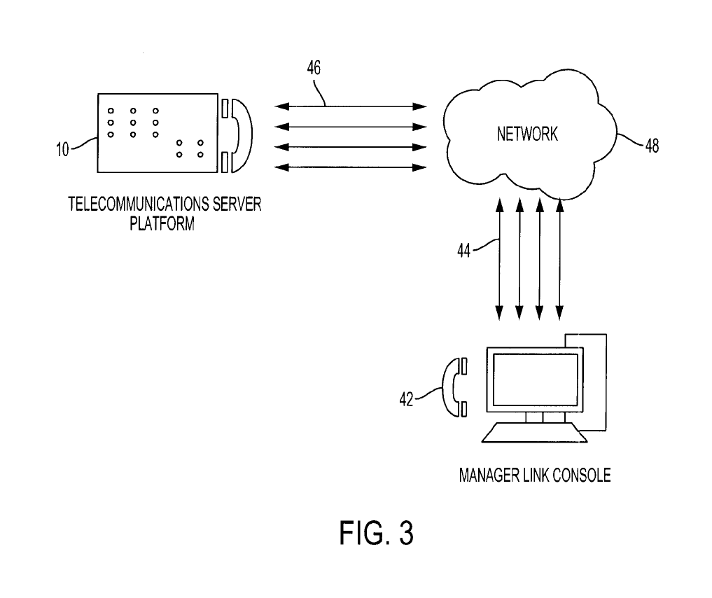

FIG. 3 illustrates a server platform 10 for cloud based telecommunications services. Telecommunications server platform 10 connects to call center manager device 42 via network 48. Server platform 10 implements a logical two-way socket data stream connection via network connections 44, 46 between devices 42 via network 48. Server platform 10 may provide cloud based telecommunication services for a call center or other communications applications. A call center may include a network of devices operated by call center agents and managers. The data socket is a logical connection between the client 42 and the server 10. The connection is established through an HTTPS/WSS session over a network 48, such as the Internet.

Call center managers, remote agents, and other users of cloud based telecommunications switching devices may experience propagation and connectivity delays, such as delays for call status information display on an interface of a display screen. This delays real-time messaging. For example, operators may experience lag and quality of service (QOS) issues when transferring calls or other communications sessions to other client devices at remote extensions. In the LCL environment the connection is established via a logical real time communications socket. This may overcome shortcomings of speed and lag on other architectures by providing a real-time communications layer.

Telecommunications server platform 40 may provide real-time call monitoring to enable managers, via manager device 42, to actively engage with and provide input for the call or other communication session in a cloud-based environment in a live fashion. Telecommunications server platform 40 may provide real time communications to touchscreen or other accessibility enabled client devices, such as manager device 42, in order to provide an integrated and satisfying user experience.

Embodiments described herein provide a server platform 40 with a real-time server communications layer. Server platform 40 employs an in-band signaling protocol within a dedicated input/output server socket to yield real-time two-way communications 44, 46 between a client device (e.g. manager device 42) utilizing the internet protocol. This communications layer allows a client device 42 to connect to the server platform 40 in a secure fashion with a communications path that is limited only by the bandwidth between the client device 42 and the server platform 40, while experiencing no lag time or degradation of voice quality.

Live Communications Link (LCL) is a web socket communications layer that allows real-time bi-directional event-based communication. The LCL socket allows bi-directional streaming of binary data. The LCL socket allows data to be pushed across an open socket channel. The data transfer rate may be limited only to the bandwidth of the network speed between the client device 42 and telecommunications server platform 40. Telecommunications server platform 40 uses the LCL to implement two-way socket data stream connections 44, 46 to client device 42. The data socket is a logical connection between the client and the server. The connection is established through an HTTPS/WSS session over the internet.

In the current landscape of PBX or other switching systems, known systems may constantly poll the server for data to display. This approach may result in slower communications that require more data resources to deliver data. As well these communications are more vulnerable to a security breach, as opposed to the LCL that only enables those with authorized access to interface with the communications stream. Access is controlled via a secured login page and is allowed by only known, validated sources. Once a request for access is received the system checks not only the requesting IP address to ensure that it is allowed access, but also the MAC address of any devices.

Live Call Communicator (LCC)

In accordance with another aspect, embodiments described herein relate to a cloud based telecommunications server platform with a live call communicator (LCC) interface that provides real-time call display monitoring and two-way interaction. As noted herein, a call may refer to a voice, video, text communication, or a combination thereof.

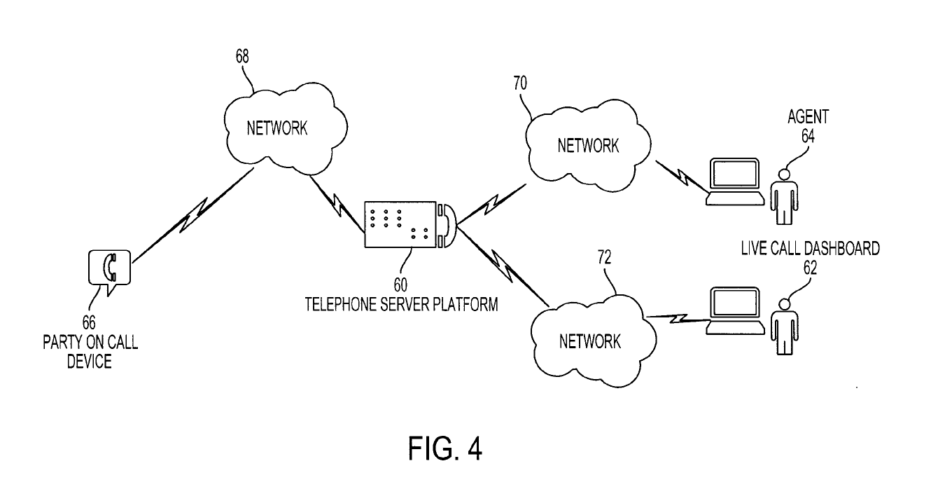

FIG. 4 illustrates a server platform 60 for cloud based telecommunications services. Telecommunications server platform 60 may provide cloud based telecommunications services for a call center. A call center may include a network of devices 62, 64 operated by call center agents and managers. Server platform 60 may establish a telecommunications call between a party on call device 66 and an agent device 64. Server platform 60 connects to party on call device 66 via network 68 and connects to call center agent device 64 via network 70. Server platform 60 connects to call center manager device 62 via network 72.

Server platform 60 provides an LCC interface for display on a display screen of a call center manager's device 62. Known system interfaces may not display and update information on the call center manager's display screen in real time to reflect employee or agent performance. The LCL is a logical connection established through a real time data socket that is a logical connection between the client and the server. The connection is established through an HTTPS/WSS session over the internet or other network.

The LCC interface establishes a live connection between telecommunications server platform 60 and manager device 62 based on the status of a current call. The status information includes the length of hold time per leg and transfer point of the call. As well as disposition such as busy, no answer and termination of the communication. LCC interface includes real time ability to monitor and intercept the voice path between a party on call device 66 and agent device 64. LCC interface provides data regarding the voice call and voice path to manager device 62 for review and/or action, as required. This link is achieved via an HTTPS/WSS layer. The LCC interface is able to provide an agent device 64 immediate assistance from a colleague or manager (e.g. another agent device 64) to join or listen to a voice call currently ongoing with party on call device 66. This is an issue in a distributed environment because of propagation delays. The LCC overcomes these propagation delays by using a logical connection established through a real time data socket that is a logical connection between the client and the server.

The LCC interface provides manager device 62 (operated by call center manager) real time control that a call center manager needs to maximize speed while reducing system lag. A real time communications layer is established between the manager device 62 display screen and the cloud based telecommunications server platform 60 to implement LCC interface. The LCC interface enables the manager device 62 to view call statistics and control interactions such as monitor, whisper (one-way conversation with the agent device 64 for coaching or sales directive), barge-in and record or transcribe a call for training at a later time. The agent device 64 can be located geographically anywhere.

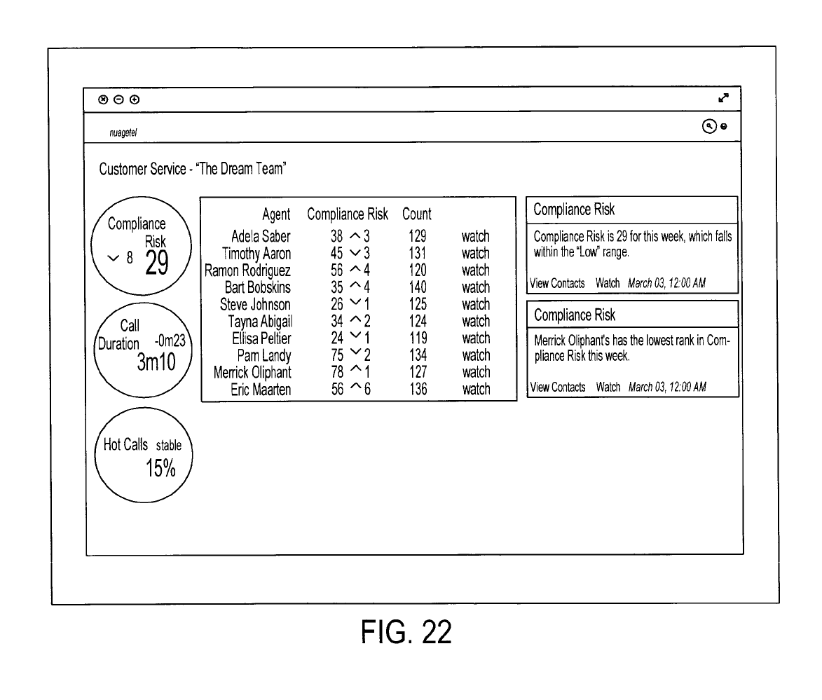

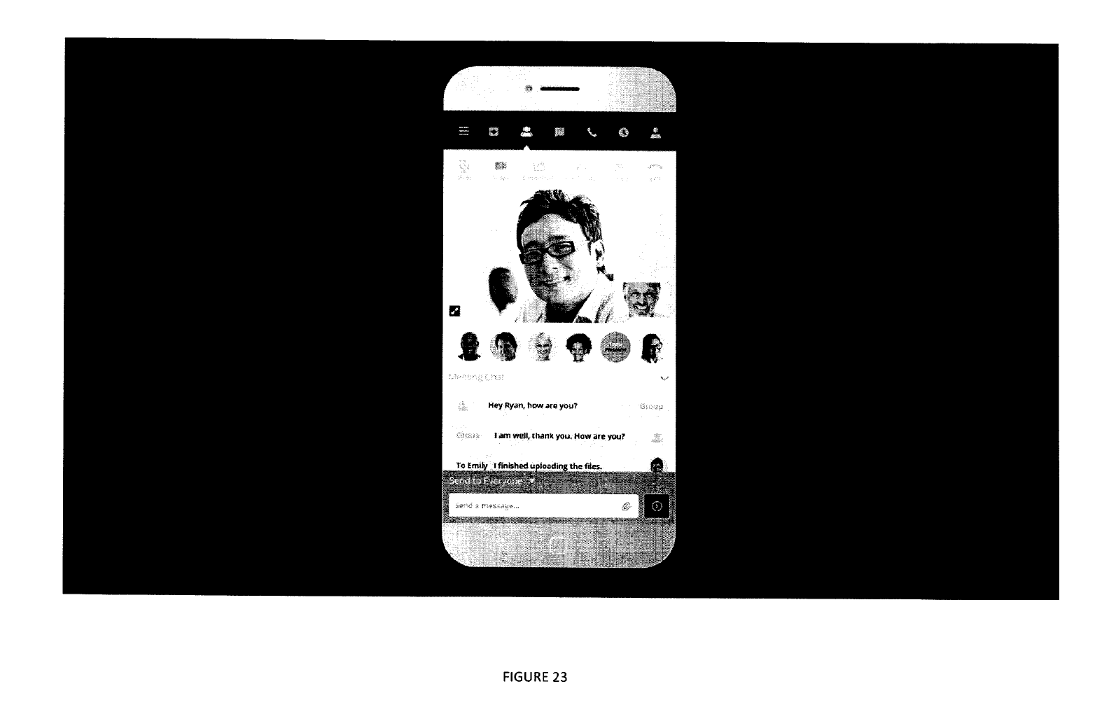

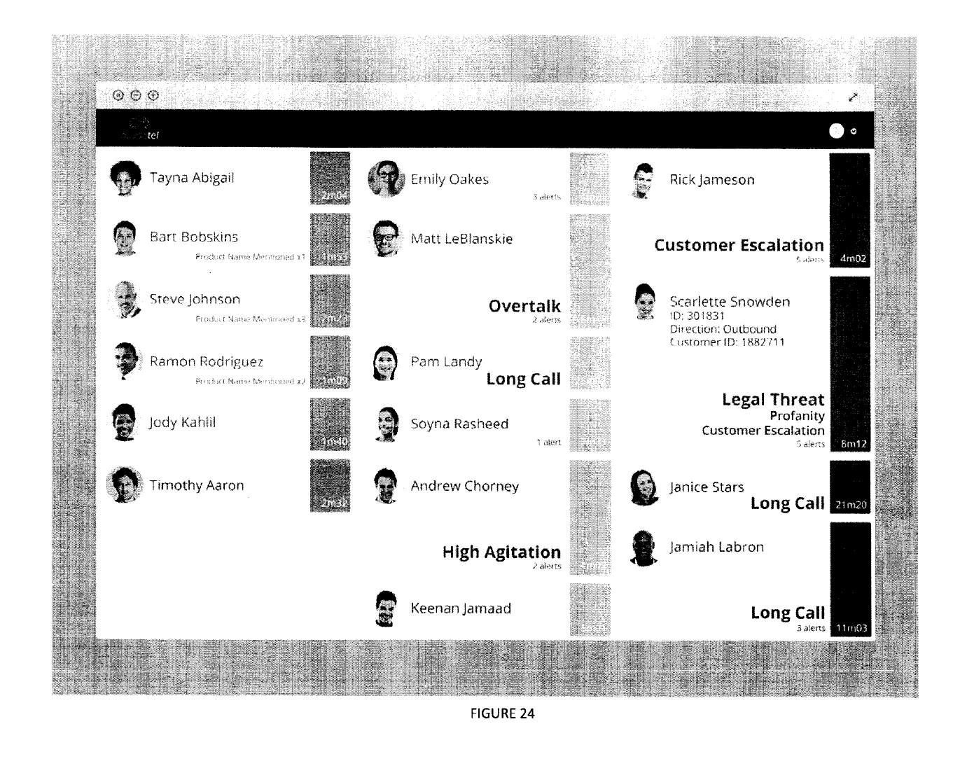

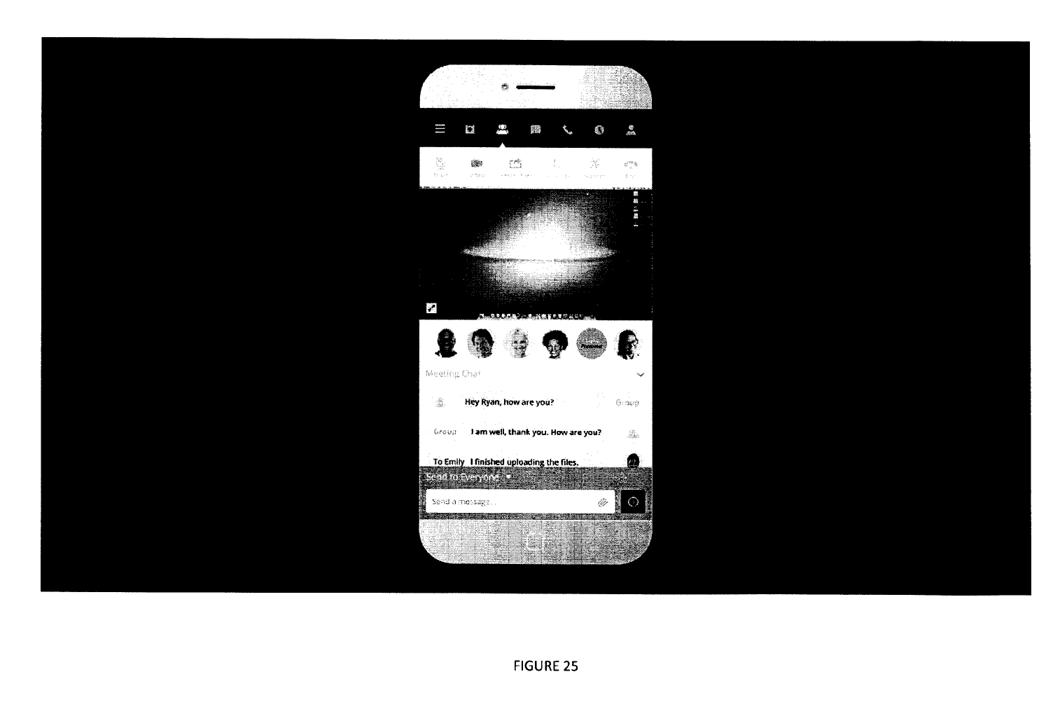

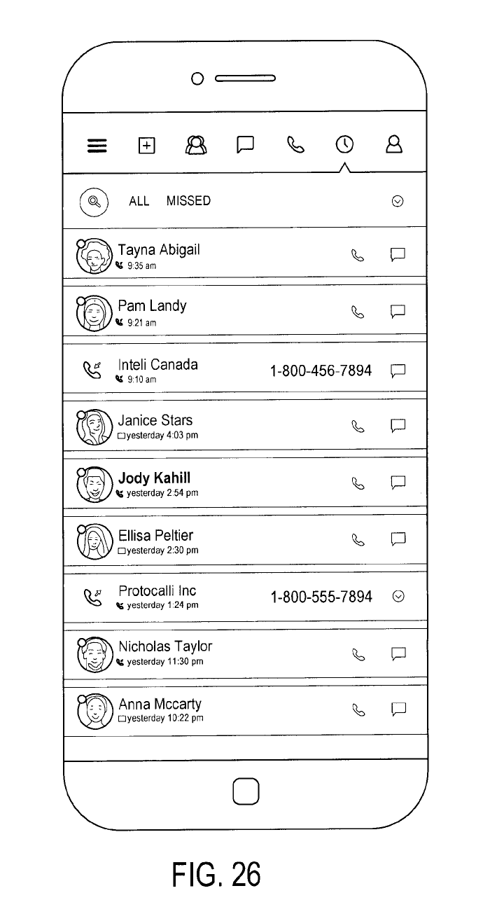

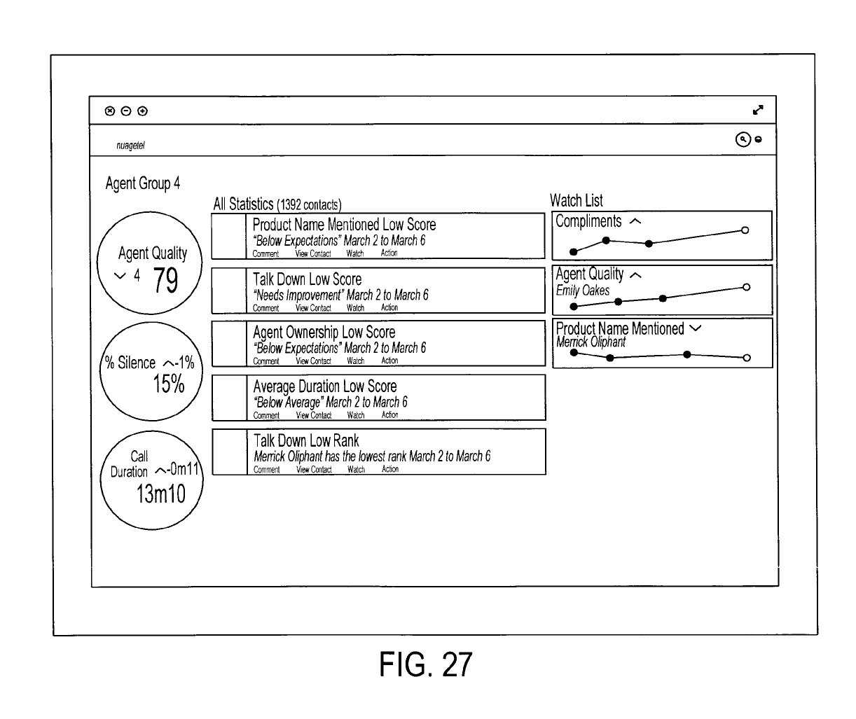

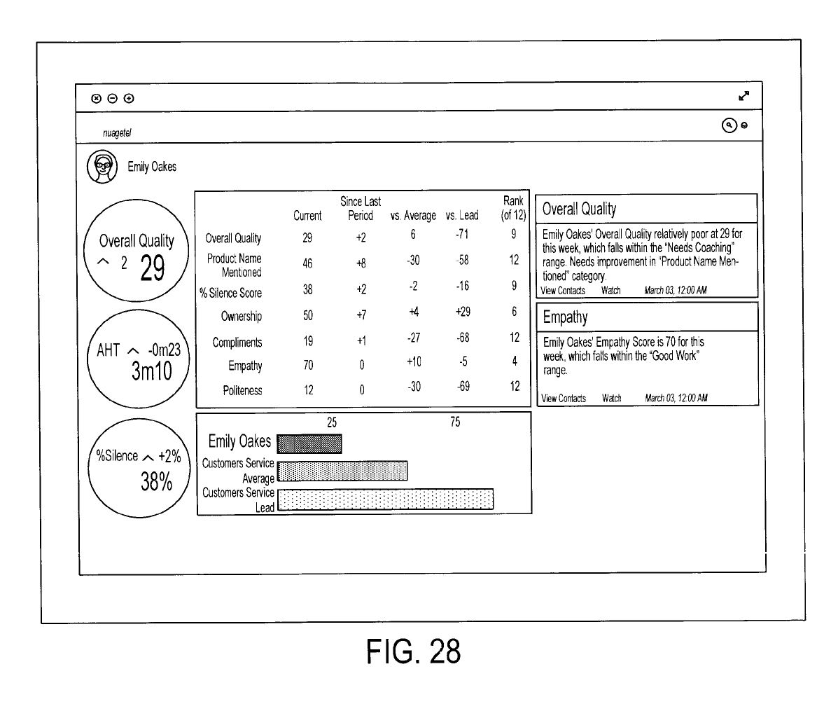

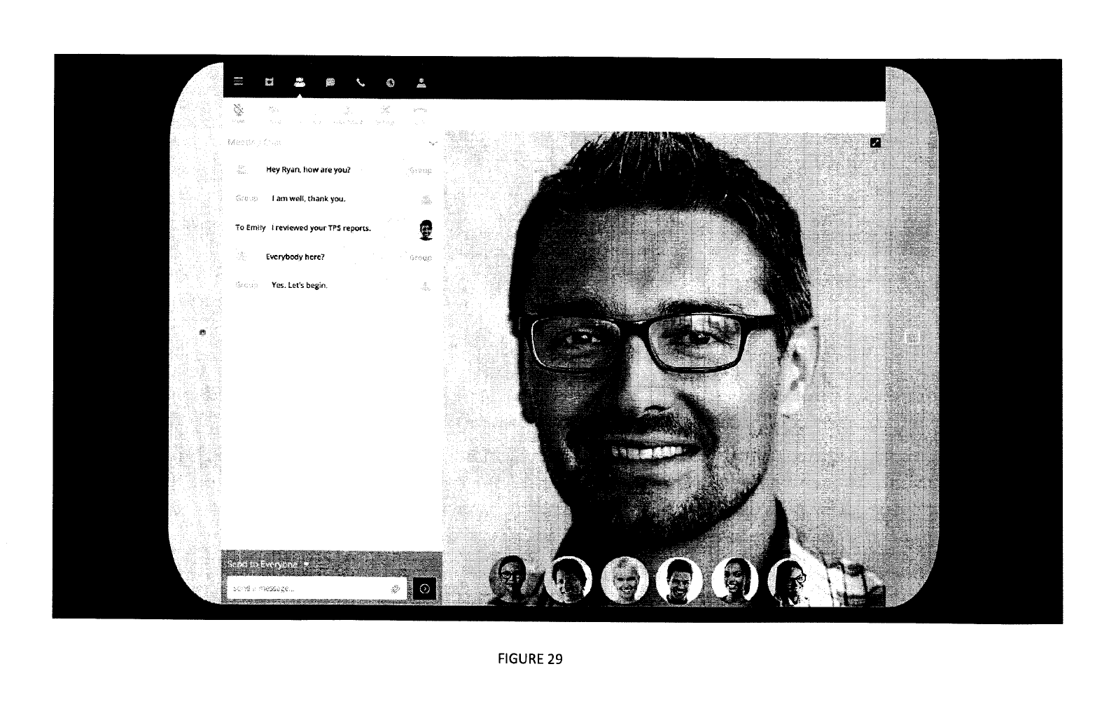

The LCC interface provides manager device 62 (operated by call center manager) a dashboard built into the system. FIG. 24 illustrates an example dashboard interface. The dashboard enables a manager the ability to monitor its agents' performance in real-time and with historical post call data with multiple analytics tools such as keyword triggers, disposition analysis, time on hold etc. FIG. 23 illustrates another example dashboard interface. Moreover, the manager can examine individual agents' performance (see FIG. 28) and agent groups' performance (see FIGS. 22 and 27). Specified suggestions are then sent to both agents and managers to maintain ongoing performance improvement or notify managers of any inappropriate actions. FIGS. 25 and 26 illustrate further example interfaces for mobile devices.

It also provides a manager the ability to take action accordingly with the ability to barge into a call and or whisper without the external caller able to hear and more. An example of this would be a manager would get an alert if a call ran longer than it should be, with profanity being used or other inappropriate protocol and they could take appropriate action.

LCC interface includes cloud based real time call center management console software that incorporates live voice, video and text communications, among others. Telecommunications server platform 60 may use a Live Communications Link (LCL) to deliver LCC interface to manager device 62 as a real time call center manager console. The LCL interface provides real time agent communications from the agent device 64 to the manager device 62 via a live socket layer, as described herein. The LCL interface provides, in a cloud based call center environment, the ability to monitor at a manager device 62 agent calls at agent device 64, instantiate a one way or two way call between a manager device 62 and an agent device 64 that is on a call with a third party (e.g. party on call device 66). LCL interface provides a mechanism for a manager at manager device 62 to monitor and review an agent or employee while he/she is on a call with the party on call device 66.

LLC interface includes an emergency call facility from a live agent at agent device 64. In addition real time keyword and phrase alert detection analysis and disposition analysis are integrated into the LLC interface. All communications are monitored in real time for predetermined logical triggers and actions to be executed.

LCL interface continuously monitors and collects data relating to the call between agent device 64 and party on call device 66 for storage and subsequent retrieval as needed. LCL interface also monitors and collects data relating to the call between agent device 64 and party on call device 66 for storage and subsequent retrieval. Real time and post time performance and call behaviour metrics and statistics are available to call center managers and other supervisors via LCL interface.

Call Routing

Embodiments described herein relate to cloud computing telecommunications systems where a telecommunications server platform implements call routing between devices to provide cloud-based telecommunications services.

Move Live Call

Embodiments described herein may provide a telecommunications server platform having a cloud based telecommunications Move Call application that seamlessly moves a call connection from one device to another device without interrupting the call in progress. This functionality is performed by a server side application which is triggered through an API call using front end applications or a third party application that invokes appropriate API calls. In some embodiments, this is a back end server side application.

For known systems, when a call is in progress, a user cannot transfer a call without putting the other party on a call on hold and then transferring that call. The caller is put on hold so the call can be transferred manually to the other device. However, this may be a disruption to the call as it is interrupted while it is being transferred.

FIG. 1 illustrates a telecommunications server platform 10 and a move call application 100 that moves a live call from one device 20 simultaneously to another device 20 without the other party on the call device 28 knowing or experiencing disruption through being put on-hold for the transfer. Server platform 10 has a server processor 30, bit level buffer 14, and detection and translation layer device 16. To establish a call connection, server platform 10 connects to party on call device 28 via network 18, and server platform 10 connects to Move Call application 100 residing on a computing device, that may include device 20 or may be a separate computing device coupled to device 20. Move Call application 100 may reside on device 20 or may be disparate from device 20 and coupled thereto.

Telecommunications server platform 10 moves a call from one device 20 to another device 20 by employing a full duplex bit level buffer 14 handoff that buffers the live call to overlap momentarily providing a seamless transfer without the communication transmission being interrupted. Both transmit and the receive bits are buffered to provide seamless communications on top of a protocol one to one server side translation layer 904.

As an illustrative example, telecommunications server platform 10 may host a conference call with multiple caller devices connected for the call. A party on a conference call may want to transfer the communications session to another device 20, however they may not want the people on the call (e.g. at call device 28) to know that they are moving the call to a device 20 located in their car.

Telecommunications server platform 90 allows a call to be transferred without interrupting the call or the flow of the conversation.

Smart Hold

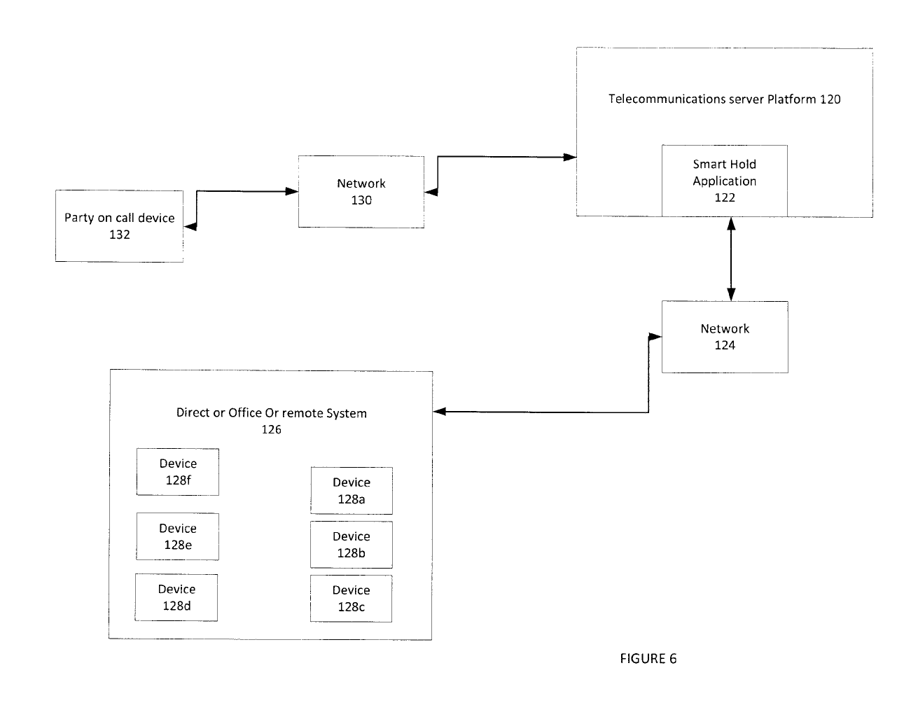

Embodiments described herein may provide a server platform having a cloud based call (or communications session, such as voice, video, messaging, and so on) hold application that provides customizable on hold messaging, message sequencing, call flows, or other messaging sequences. A Smart Hold application 122 (FIG. 6) processes call or other communication session related data with variable and dynamic granularity to select predetermined hold or other interactive message configurations. Granularity refers to the level of detail that a query can be based upon depending on the information/digits received as input. For example a message could be played or an action could be specified to the level of the individual caller or to the caller's region (country, area code, city or individual) depending upon the “granularity” (expressed in digits to read) of the users selection.

Businesses, marketers, managers and other stakeholders may use the Smart Hold application for unique on-hold messaging to be dynamically and automatically selected and played to a caller based upon call related data, including the caller ID number, dialed number, preferences, session initiation protocol (SIP) addresses that they are calling from, or other communications session related data. The SIP address is a uniform resource identifier to address a specific extension, user or destination for a VoIP or other communications system.

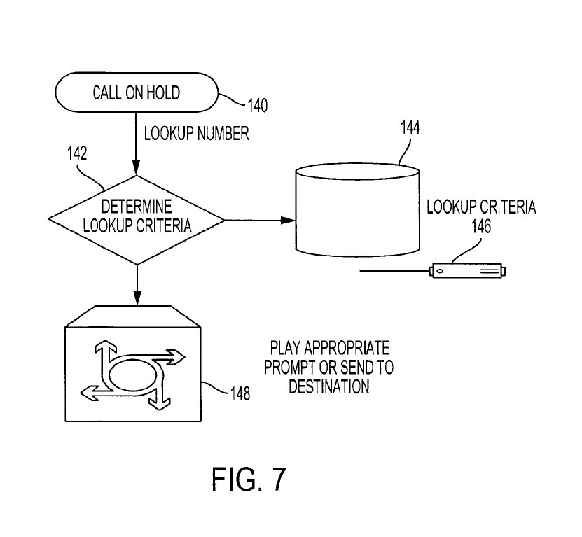

FIGS. 6 and 7 illustrate a telecommunications server platform 120 with Smart Hold application 122. Server platform 120 has a processor and memory and implements cloud based telecommunications services as described herein. To establish a communications session connection, server platform 120 connects to party on call device 132 via network 130, and telecommunications server platform 120 connects to local users or remote system 126 via network 124, where remote user system 126 has a network of computing devices 128a-128f.

FIG. 7 illustrates a data flow for Smart Hold application 122. At 140, Smart Hold application 122 detects that an incoming telecommunications call or other communications session (video, messaging, text, voice or other) is on hold or about to be put on hold.

At 142, the Smart Hold application 122 determines lookup criteria 146 and processes call related data for the incoming call or other communication session (video, messaging, text, voice or other) to identify the appropriate on hold message or message sequence. A data store 144 stores hold message records linking lookup criteria 146 to data content defining hold messages. The lookup criteria 146 is used to identify and retrieve a hold message record in data store 144 to obtain the data defining a hold message appropriate for a particular incoming call for playback while on hold. The call related data may be used as lookup criteria 146, or processed to identify additional lookup criteria 146. For example, the Smart Hold application 122 may read the number or SIP address for the incoming call to determine the appropriate message to play to the caller while they are on hold. The number or the SIP address are examples of call related data. The call related data may be used as lookup criteria 146 to retrieve a hold message record from the data store 144. The call related data may also be processed by Smart Hold application 122 to determine lookup criteria 146. For example, the call related data may be processed to identify a relevant geographic location, where the geographic location may be used as lookup criteria 146. The Smart Hold application 122 may use the geographic location (as lookup criteria 146) to retrieve the appropriate hold message record from the data store 144. Other examples of data derived by processing call related data includes geographic data, demographic data, and historical data (e.g. previous purchase information).

The Smart Hold application 122 may implement caller ID technology to access the incoming call number and use this call related data as lookup criteria 146, or to determine lookup criteria 146 for a call to data store 144 to identify and retrieve the message, or the sequence of messaging that will be played to the caller on-hold. The sequence of messaging may be defined by hold message records (e.g. by a pointer to another hold message record to play next in the sequence) or may be defined by a separate message sequence record linking to multiple hold message records to define a sequence of multiple messages to play.

The Smart Hold application 122 may also consider responses to user prompts or inputted data (such as purchase data, demographics, geographic location, and so on) to determine the appropriate hold message(s). The selection of user prompts may be dynamically determined using initial call related data, such as the number, SIP address of the incoming call, geographic location, or dialed number. This enables a dynamic selection of customized or targeted user prompts that can enhance and improve a user or caller's experience. The user input in response to the user prompts may provide the additional data for Smart Hold application 122 when determining the appropriate hold message(s).

At 148, the Smart Hold application 122 triggers playback of the data defining the hold message or other communication (video, messaging, text, voice or other) of the retrieved message hold record from the data store 144 for the caller (at party on call device 132) on the incoming call or other communication session on hold.

The Smart Hold application 122 may provide a graphical user interface for a caller of the incoming call, an agent device used by a call center agent, or a manager device used by a call center manager provided to easily configure hold message functionality. The graphical user interface may be optimized for touchscreen or other input device. Moreover, the messaging data used for the hold message records can be controlled, updated, modified, or created based upon input and or criteria from a third party messaging application. The messaging application may be integrated with Smart Hold application 122 through data queries through an API such as RESTful API-cfAPI Interface or other connection to obtain maximum compatibility with third-party messaging or other communications systems.

Example hold messaging includes customized marketing messaging, text, audio, video that includes lookups to data store 144 using particular lookup criteria 146 to tailor messaging based on geographic data, demographic data, historical data, and so on. Another example of hold messaging includes situational emergency messaging, such as natural disaster or weather event emergency protocol in a given area.

The Smart Hold application 122 provides a dynamic customized hold message which provides an enhanced user experience over static general messages played to all callers while they are on hold, or over messages that require direct manual user input of selection or preference that is not intuitive and dynamically tailored to the caller or user.

The Smart Hold application 122 processes call or communications related data such as the dialed number or the caller ID number to determine the appropriate message or call flow to present to a caller of an incoming call on hold or to be placed on hold. The action that the Smart Hold application 122 performs is variable to every caller and or caller ID number. The Smart Hold application 122 can perform the desired action down to a level of 1 digit granularity for the number as well up to 999 digits (as an example range) of granularity for the number simultaneously. An example of this is a message played to users or callers with a 416 area code. This may be independent of the caller ID number or dialed number thereby allowing the Smart Hold application 122 to perform different actions on each call by caller ID number and/or dialed number, or other criteria.

Performance Based Dynamic Traffic Management

Embodiments described herein may provide a telecommunications server platform implementing performance based dynamic traffic management. Telecommunications server platform provides a cloud based telecommunications switching platform with a traffic management application that manages routing call traffic data packets using dynamic input and routing criteria. The traffic management application controls what physical network components are used for different call connections. Each call connection may be defined by an array of network hardware components.

Traffic management application may be used by call center managers to adjust the flow rate and the amount of calls being transferred to different agent/user devices based upon various metrics or criteria, such as performance, specialization, geographic location.

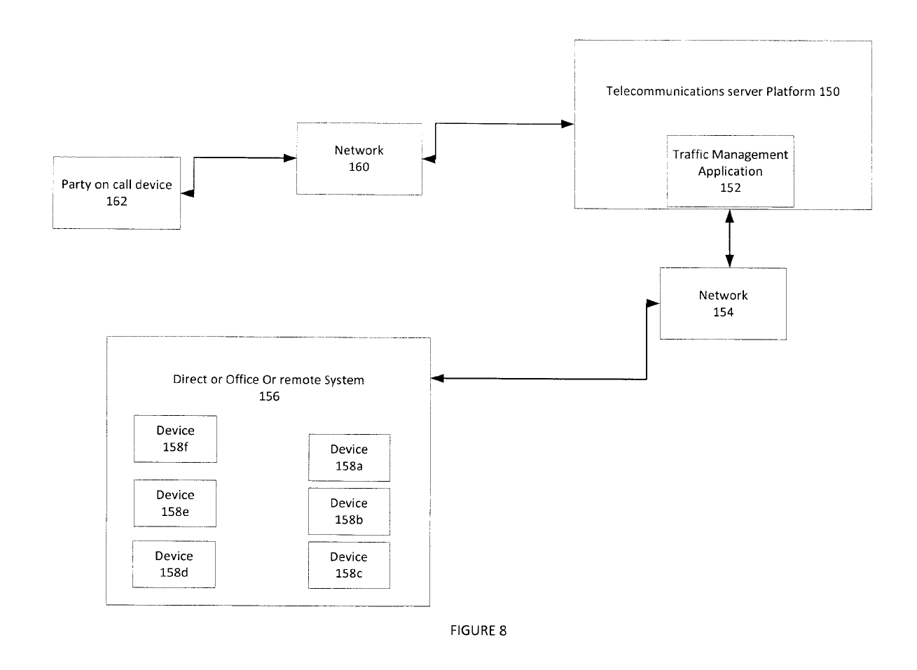

FIG. 8 illustrates a server platform 150 with traffic management application 152. Server platform 150 has a processor and memory and implements cloud based telecommunications services as described herein. For a call or other communication connection, telecommunications server platform 150 connects to party on call device 162 via network 160, and telecommunications server platform 150 connects to office system 156 via network 154, where remote system 156 has a network of computing devices 158a-158f (remote or local).

Traffic management application 152 controls the flow rate and volume of calls to an agent/user device 158a-158f of a system 156 based upon input and or criteria such as performance, specialization, geographic location from a third party application (e.g. data sources access through an API or other connection, direct or indirect). This control may be achieved through data queries to traffic management application 152 through an application programming interface (API) such as a RESTful API-CFAPI (Call Flow API) Interface, for example.

Traffic management application 152 enables managers via manager devices to automatically adjust the flow of call traffic to specific agent/user devices using routing commands based upon volume and agent efficiency to reduce call waiting times. Traffic management application 152 accesses user/agent records storing historical data regarding agent efficiency, hang times and other criteria in order to adjust flow of traffic based on historical metrics computed using the historical agent data. For example, each agent record may include a maximum volume capacity data field or an optimal volume capacity data field that may be referenced by traffic management application 152 for traffic management. Traffic management application 152 may continuously calculate real time data regarding call volume and efficiency rates for users/agents, such as, current volume per agent, total current volume, average call waiting time, current estimated waiting time per call, current estimated waiting time per agent, average volume per agent, average length of call per agent, average volume per agent, specialization, location, and so on. During peak times calls can be routed by traffic management application 152 to faster agents based on calculated efficiency rates per agent, and other data factor criteria.

Traffic management application 152 enables agents to be rewarded and conversely penalized based upon user feedback data, efficiency rates, and so on. Feedback data may be received as input data from a website or other data source. An agent may receive fewer calls if feedback is negative, for example.

Traffic management application 152 may filter all communication or call flow dynamically based on various metrics, such as expertise of each individual agent during certain call flow periods. Traffic management application establishes a different call connection to connect party on call device 162 to an agent device 158 depending on the dynamic selection of the appropriate agent device 158.

Traffic management application 152 implements a software process that measures call traffic statistics both historically based upon agent performance, script and queue type in real time to make intelligent rule based routing decisions on the fly to dynamically alter hold times in a cloud based call center environment.

Traffic management application 152 manages communication flow more efficiently than an approach based on a manual process of distributing calls based upon manual manager selection of agents. Traffic management application 152 provides an automated dynamic solution instead of a manual static process controlled and mandated by a manager.

Distributed Network Call Processing

Embodiments described herein may provide a telecommunications server platform implementing distributed network call processing (DNCP). Embodiments described herein may provide a telecommunications server platform that implements a dynamic load balancer for reassigning new transactions in a redundant network to predict and balance the load amongst geographically diverse servers. Example transactions may be call connections between remote devices for calls, chat sessions, file transfers, and screen sharing, text messages, whiteboard applications, facsimile transmissions and conferencing applications, and so on.

In either a premises based call switching platform or even in a distributed or cloud environment there may be many single points of failure (such as defective hardware or communications link outages) due to the reliance on a singular PBX server in one geographic location. These single points of failure increase the likelihood of call processing errors or system downtime.

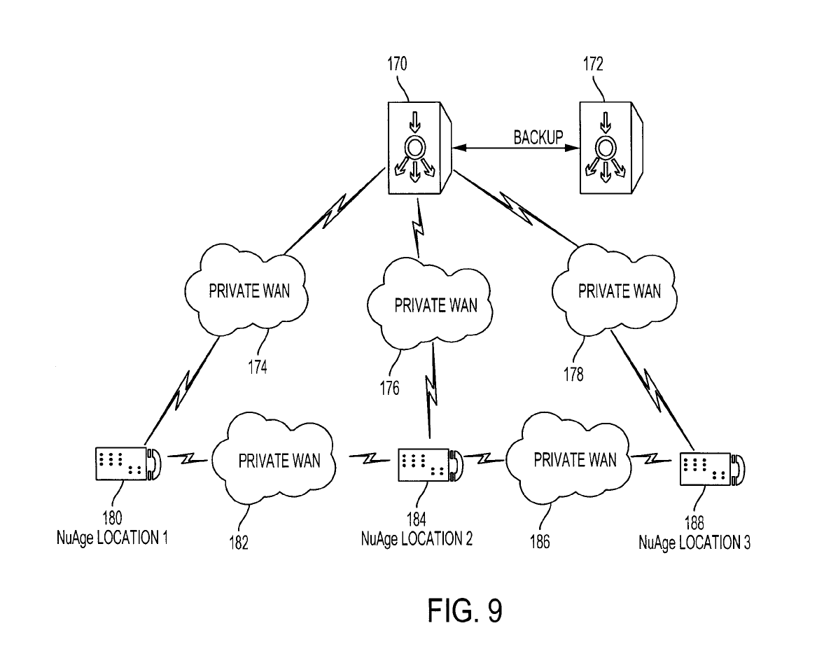

FIG. 9 illustrates a schematic diagram of a traffic distribution manager platform 170 for dynamic load balancing. Telecommunications server platform 180 implements load balancing by establishing call connections using different telecommunications server platforms in different locations depending on dynamic criteria to distribute call traffic across the different geographic locations. Traffic distribution manager platform 170 connects to a telecommunications server platform 180 in a first location (e.g. Location 1) via private wide area network 174. Traffic distribution manager platform 170 connects to a telecommunications server platform 184 in a second location (e.g. Location 2) via private wide area network 176. Traffic distribution manager platform 170 connects to a telecommunications server platform 188 in a third location (e.g. Location 3) via private wide area network 178. Telecommunications server platform 180 in the first location (e.g. Location 1) connects to telecommunications server platform 184 in the second location (e.g. Location 2) via private wide area network 182. Telecommunications server platform 184 in the second location (e.g. Location 2) connects to telecommunications server platform 188 in the third location (e.g. Location 3) via private wide area network 186. This is an illustrative example and there may be more or less telecommunications server platforms 180, 184, 188 connected to traffic distribution manager platform 170 for additional redundancy. For a call, telecommunications server platforms 180, 184, 188 connect party on call devices to other devices (e.g. agent device, manager device, client device) via networks, as described herein. Traffic distribution manager platform 170 selects which telecommunications server platform 180, 184, 188 to use for a call connection between devices dynamically and in real time to distribute call traffic.

Traffic distribution manager platform 170 reduces the number of points of failure for a call connection by distributing the call traffic across a geographically diverse set of switching terminals (e.g. telecommunications server platform 180, 184, 188). If there is failure in one hardware component of a telecommunications server platform 180, 184, 188 or network associated therewith, only the communications connections that are in progress of being established will fail. Traffic distribution manager platform 170 also reduces down time in a distributed system due to its ability to “self-heal” network or platform failures by re-routing call traffic to different platforms.

Traffic distribution manager platform 170 uses a call distribution process to intelligently distribute calls amongst our various telecommunications server platforms 180, 184, 188. The distribution process may be referred to as “RQD” (Request Distribution). Request Distribution is a process that determines the most appropriate node to send a communication or call to. The RQD selects the node that will process the transmission the quickest as well as balance the load on each server node. The RQD process dynamically distributes the traffic based upon Time of Day, Day of week, User Statistics (e.g. average call time including specific marketing campaign call time statistics), Dialed Number, Call Origination, Closest Physical Node, Ping time as well as other criteria.

Traffic distribution manager platform 170 implements a load balancing process that predictively determines a server access time through ping testing and statistical analysis based upon several criteria including time of day, day of week/year to predetermine the fastest route. Traffic distribution manager platform 170 uses ping testing to collect statistical data metrics for hardware components used for the call connection. For example, traffic distribution manager platform 170 may transmit ping test packets to different telecommunications server platforms 180, 184, 188 to determine the fastest route. Traffic distribution manager platform 170 may collect reply message packets from different transmission hardware in response to the ping test packets.

Traffic distribution manager platform 170 uses statistical analysis to determine the probable duration of a call (derived from the average time of call weighed geographically, demographically and time of day combined with the same criteria applied to the agents performance on average or by a specific campaign) to choose the appropriate telecommunications server platform 180, 184, 188 to balance the load. In some example embodiments, the network design includes a minimum of three geographically diverse telecommunications server platforms 180, 184, 188 in a triangulated network pattern to ensure maximum uptime. If a communications link between any of the nodes is severed, traffic can still flow between the other two with minimal degradation in the quality of service.

Traffic distribution manager platform 170 provides redundancy across geographical locations to minimize service disruption in the event of hardware failure on any of the locations. Traffic distribution manager platform 170 monitors server status for each connected telecommunications server platforms 180, 184, 188 and implements sophisticated traffic distribution to ensure quick response times.

Known approaches may duplicate hardware so that if hardware breaks it can be replaced or repaired quickly. Known approaches may have redundant hardware so that every call is processed twice and if one hardware channel fails the other is in place ready to process transactions. Traffic distribution manager platform 170 implements a distributed solution that provides for an efficient and secure processing of calls in a cloud environment.

Traffic distribution manager platform 170 implements a solution with fewer single points of failure in a single geographic location by distributing the exchange of call data packets over different network hardware components located in different geographic areas. The solution may also provide greater uptime. An example of this would a weather disaster that wipes out a communication server, requiring immediate dynamic rerouting to an operation one.

User Interface

Embodiments described herein relate to cloud computing telecommunications systems where a server platform implements a user interface to provide cloud-based telecommunication services.

Easy Touch Transfer

Embodiments described herein may provide a telecommunications server platform implementing user interface components for a computing device (mobile, PC, Mac, or browser based such as WebRTC, and so on) to transfer communications sessions (such as text, audio or video calls) to computing devices operated by attendants or operators in a distributed cloud based telecommunication processing environment.

Attendants and operators need to manage high volumes of communications (such as audio or video calls) more efficiently and expeditiously. They also have the requirement to reduce desk space. Moreover, hardware and hardware specific user training costs must be controlled for businesses.

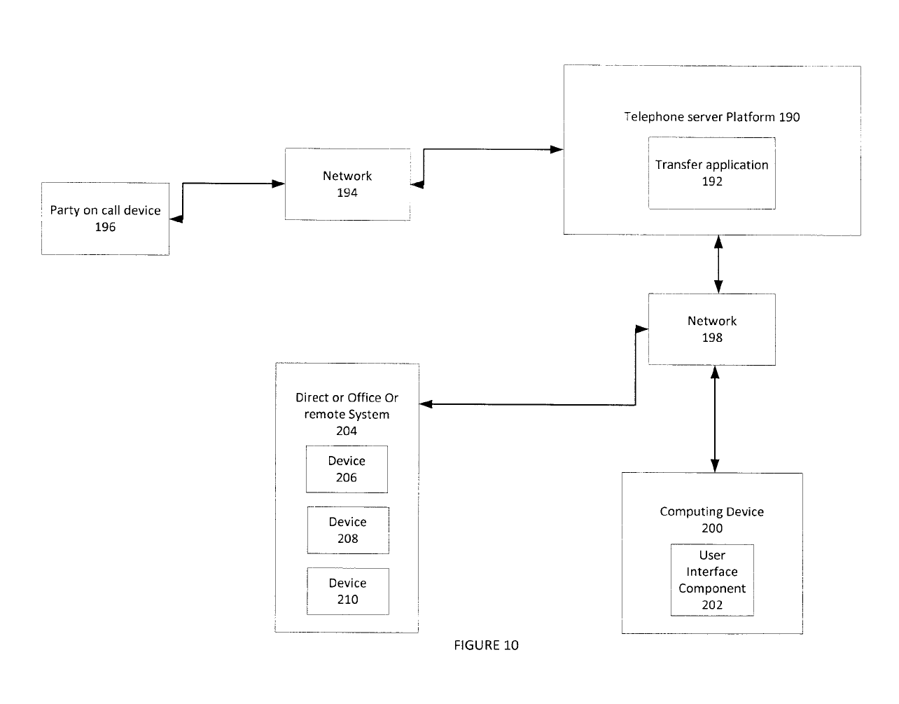

FIG. 10 illustrates a telecommunications server platform 190 with transfer application 192 that interacts with user interface component 202 of computing device 200 to transfer calls or other communication sessions. Transfer application 192 receives transfer commands from user interface component 202 resulting from user interactions with user interface component 202. In response, transfer application 192 triggers the logical or physical transfer of a communication session by updating or establishing a communications connection. An attendant or operator may operate computer device 200 running user interface component 202.

Telecommunications server platform 190 has a processor and memory and implements cloud based telecommunications services as described herein. For a communications session (voice, video, messaging etc.) connection, telecommunications server platform 190 connects to party on call device 196 via network 194, and server platform 190 connects to computer device 200 and remote users or office system 204 via network 198, where remote users or office system 204 has a network of computing devices 206, 208, 210. Attendants or operators may operate computing devices 206, 208, 210. Computing device 200 running user interface component 202 may be part of office system 204 or may be separate or remote from office system 204. Office system 204 may group computing device 200, 206, 208, 210 as call groups or department groups, for example.

An initial communications session (voice, video, messaging etc.) connection may connect a party on call device 196 to an initial computing device 200, 206, 208, 210. Transferring a communication session (audio, video call) using user interface component 202 and transfer application 192 results in updating the initial communications session connection to connect the party on call device 196 to a different computing device 200, 206, 208, 210. In some example embodiments, there may not be an initial call connection. In such case, transferring a communication session using user interface component 202 and transfer application 192 may also result in establishing a new communication session connection to connect the party on call device 196 to a selected computing device 200, 206, 208, 210, or to a third party device.

User interface component 202 receives transfer commands from user interactions, and transmits those transfer commands to transfer application 192. In response, transfer application 192 transfers the communications session by updating the communications connection. This transfer command is issued through the front end graphical interface to the back end communications server 10 via an API. A transfer command includes a transfer identifier to identify the transfer request, a communications session identifier that identifies a party on call device and an attendee identifier that identifies an attendee device or group of attendee devices to transfer a communications connection to as well as other information such as time on hold for all legs of a communications session including all telephony information such as Caller ID for automatic lookups, and so on.

Computing device 200 may be a touch enabled device with a touch screen display or other interactive touch hardware component as well as a pointing device such as a computer mouse or stylus and or virtual and or augmented reality platforms. User interface component 202 for the computing device 200 provides a graphical representation of a communications session on a display screen, and may also provide graphical representations of potential transfer devices 200, 206, 208, 210, or group thereof that are available for the call transfer. The graphical representations may show a ranking of devices 200 based on various metrics, such as time on call, to assist with the call transfer selection. The potential transfer computing devices 200, 206, 208, 210 may be an extension, call group or department queue, for example. User interface component 202 receives one or more user interactions (e.g. touch) with the graphical representation of the call on the display screen to select a graphical representation of the transfer computing device 200, 206, 208, 210, which triggers transmission of a transfer command to transfer application 192. For example, a user interaction may be a drag and drop of the graphical representation of the communication on the display screen onto the graphical representation of the transfer device 200, 206, 208, 210 representing an extension, call group or department queue, and/or external destination such as a third party telephone number or SIP address. The transfer command triggers the transfer application 192 to implement operations to physically transfer or update the communication connection to connect the party on call device 196 to the selected transfer device 200, 206, 208, 210 representing the extension, call group or department queue, and/or external destination such as a third party telephone number or SIP address. User interface component 202 for the computing device 200 enables the attendant or operator to handle a larger volume of communications more efficiently.

This functionality enables communication session transfer using the user interface component 202 by user interaction (e.g. touch) with input hardware (e.g. a mouse or touch screen display or virtual reality input) of the computing device 200. For example, user interface component 202 enables a user to drag or otherwise interact with a graphical representation of a call or communication session to transfer the call or communication session to a computing device extension, such as by touching and moving the graphical representation of an available attendant (using computing device 200, 206, 208, 210) for the call to the graphical representation of the communication itself as well as data outlining details of the communication session, or vice versa.

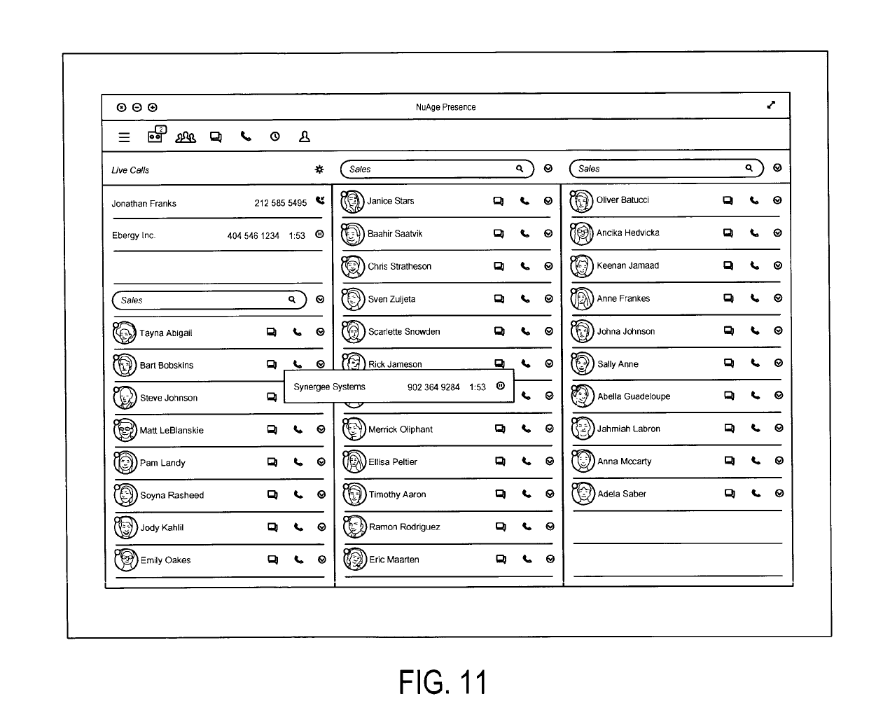

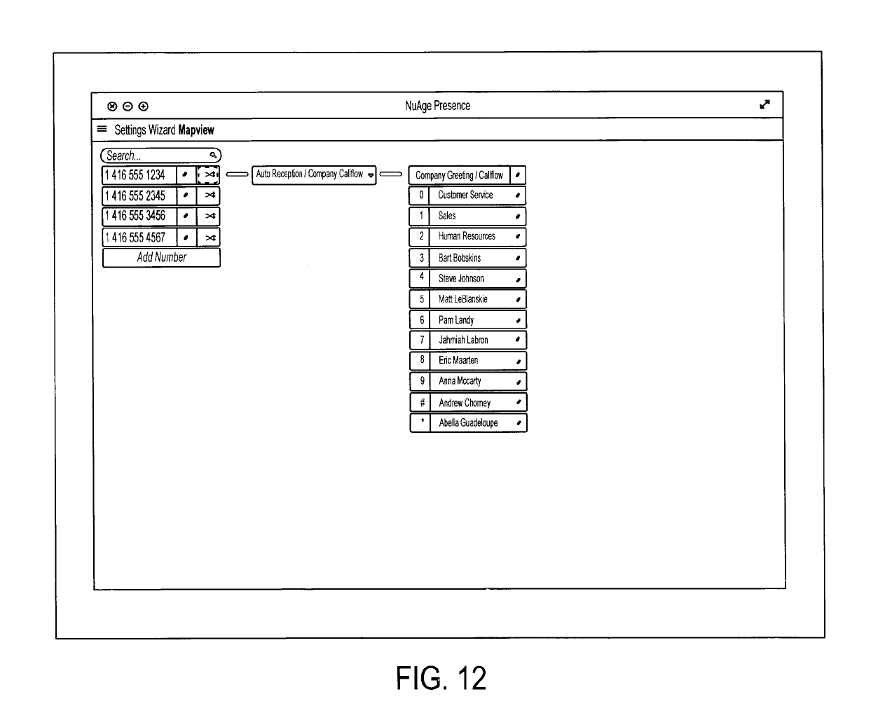

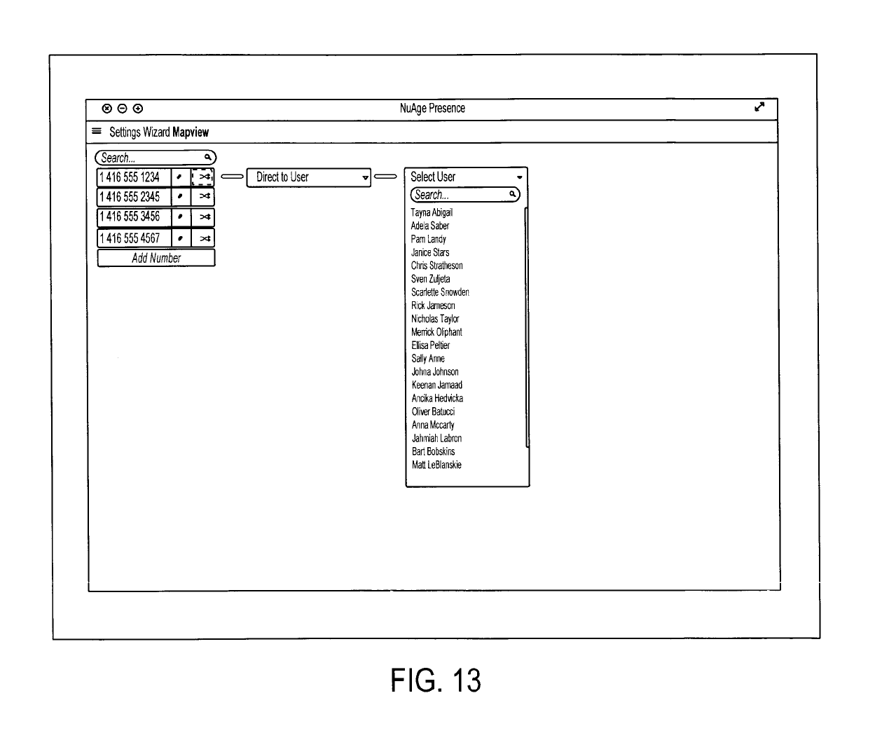

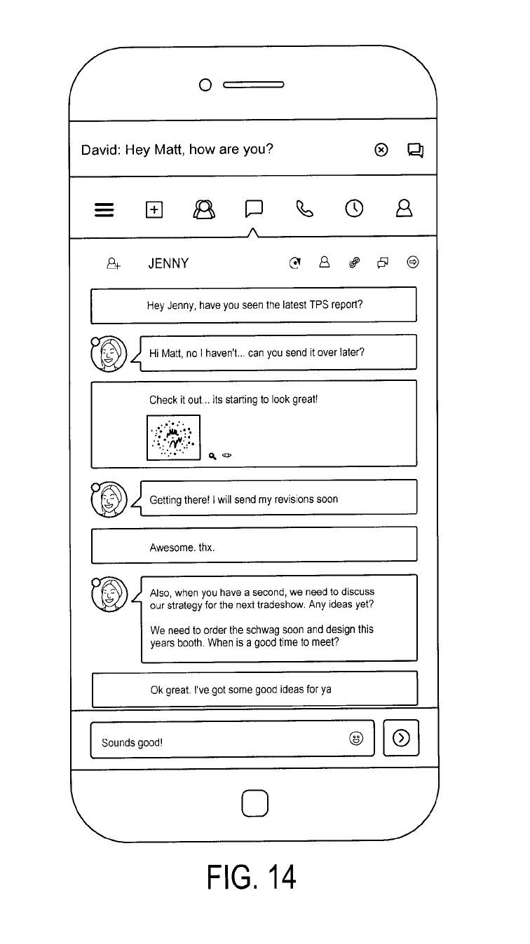

FIG. 11 illustrates an example screen shot for user interface component 202 on various types of computing devices 202. User interface component 202 may be running in a browser of a computer, such as a tablet or touch screen device or a mobile smartphone device. The screen shots may be from various devices and illustrate graphical representations of attendant that the communication can be transferred to. Using the user interface component 202, a call can be transferred from one extension or attendant computing device to another attendant by simply dragging one graphical representation to the other graphical representation of the destination (such as user, call group or department). FIGS. 12 and 13 illustrate further example interfaces. FIG. 14 illustrates example mobile interfaces.

User interface component 202 provides a seamless graphical and call management interface. User interface component 202 transmits the transfer command to transfer application 192 to control the required switching hardware and software to physically transfer the communication (voice, video messaging etc.) using an API.

User interface component 202 streamlines the job of an operator attendant that may reduce time to transfer of each communication. Even a small reduction in time can result in a large increase in efficiency for high communication volumes.

One Touch Conference

Embodiments described herein may provide a telecommunications server platform implementing conference communication (voice, video, messaging etc.) connections via a single action or user interaction with a user interface component of a computing device for cloud-based telecommunication services. The single action may be referred to as a one-step or one-touch operation to establish a conference connection between multiple devices either inside (e.g. subscriber or user) and outside (e.g. third party) the system.

There exists a need to have a clear graphical representation of a given communications session status, activities and members or participants in real-time.

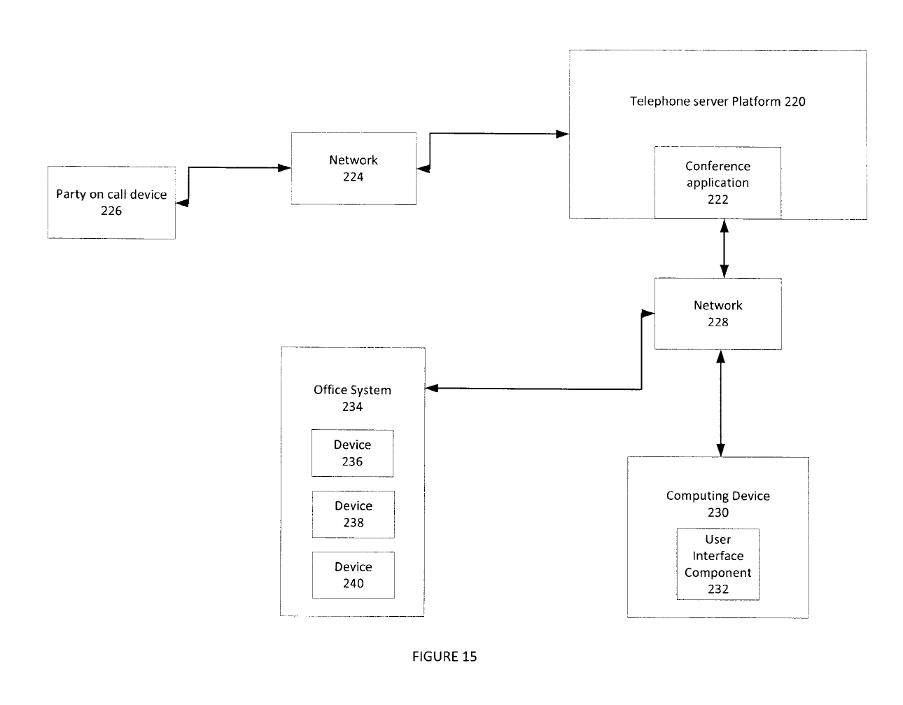

FIG. 15 illustrates a telecommunications server platform 220 with transfer application 222 that interacts with user interface component 232 of a computing device 230 to connect parties on various devices in a conference call connection (e.g. voice, video, messaging) in response to conference commands resulting from a single user interaction with user interface component 202. An attendant or operator may operate computer device 230. The conference communication session connection may involve one or more party on call devices 226 and one or more other devices 236, 238, 240 connected via telecommunications service platform 220. Telecommunications server platform 220 has a processor and memory and implements cloud based telecommunications services as described herein. For a conference communications session connection (e.g. voice, video, messaging, and so on), telecommunications server platform 220 connects to party on call device 226 via network 224, and telecommunications server platform 220 connects to computer device 230 or one or more computing devices 236, 238, 240 connected by direct or remote or office system 234 via network 198. Attendants or operators may operate computing devices 236, 238, 240. Computing device 230 with user interface component 232 may be part of a direct or office or remote system 234 (premises or not premised based, cloud based).

The user interface component 232 provides a graphical representation of different real-time attributes for a conference communication session connection including, a status, activities and participants or member. The user interface component 232 may also provide a graphical representation of available attendants, operators, or other users for the conference communication session. The user interface component 232 establishes or updates a conference communication session connection in response to a single action or user interaction with input hardware of the computing device 230.

A conference communication session connection connects one or more party on call devices 226 to one or more other computing devices 230, 236, 238, 240. Adding another device to the conference communication session (voice, video, messaging, etc.) connection results in updating the initial conference connection to connect the additional computing device 230, 236, 238, 240. As noted, user interface component 232 adds another computing device to an existing conference communication connection in response to a single action or user interaction in order to extend the conference communication session connection. In some example embodiments, there may not be an initial conference connection. In such case, establishing a conference communication session connection using user interface component 232 and conference application 222 may also result in new communication session connection(s) to connect the party on call (or other communication) device(s) 226 to the selected computing device(s) 230, 236, 238, 240. User interface component 232 triggers generation of the initial conference connection in response to a single action or user interaction with input hardware of computing device 230.

As an example, user interface component 232 detect a “drag and drop” or other trigger action for graphical representation of a live communications session as a single action to trigger the conference communications session connection (video, voice, messaging). User interface component 232 may provide a graphical web based touch optimised user interface and or mouse optimised user interface for display on display screen of computing device 230. User interface component 232 allows live communication sessions and session status information or attributes to be visually or graphically represented to the user on display screen of computing device 230. This allows the user to simply drag one communications session (graphically represented) icon on top of another communications session (voice, video, messaging) icon using a user interface component 232 (e.g. touch based interface or a mouse type user interface or stylus and or virtual and or augmented reality platforms). This may facilitate touch based or other drag and drop features for ease of use, and reduction of user training.

FIGS. 11 and 14 illustrate example screen shot images of user interface component 232 to demonstrate the ability to drag any communications session icon that is represented in the “Live Calls” section on top of another communications icon to trigger a conference communications session connection or other transmission session.

Accordingly, user interface component 232 provides an easy-to-use graphical, real-time touch based (or other input method) or other drag-and-drop user interface. The ‘drag-and drop’ is an example single action to trigger the conference communications session connection, and other single actions may be used such as activation of an input device or selection of a communications session icon, and so on.

Previous solutions require a “two-step” call transfer or conference process, and user interface component 232 provides a “one-step” or single action call transfer or conference process. This involves pausing the call for both parties, putting the call on hold, and then another action to join each leg of the session.

For a conference call, user interface component 232 may provide an indication of the single action to be performed to trigger the conference communications session connection. User interface component 232 provides a graphical representation of a live communications session, along with real-time attributes or status thereof. User interface component 232 detects the single action or user interaction at input hardware (e.g. touch display screen) and, in response, generates a conference communications session command through the server platform 220 API. The conference command includes a call identifier that identifies the live call for the conference, and device or attendant identifiers that identify one or more computing devices to add to the conference communication session connection to the backend server platform 220. Computing device 230 transmits the conference command to conference application 222. The conference command triggers the conference application 222 to implement operations to physically or logically establish or update the conference communication session connection, via the message switching layer 900 (FIG. 1), for example, to connect the party on call device 226 to the computing device 230, 236, 238, 240 associated with the selected graphical representation or icon. User interface component 232 for the computing device 230 enables the attendant or operator to efficiently establish conference call connections.

Data Analytics

Embodiments described herein relate to cloud computing telecommunications systems where a telecommunications server platform implementing a phrase detection component to process voice data to identify phrases of interest and trigger to external actions.

Real Time In-Call Phrase Detection

Embodiments described herein may provide a telecommunications server platform implementing a phrase detection component for real-time phrase detection within voice data for a live communications session in progress on the distributed cloud based telecommunications processing environment of the telecommunications server platform.

Embodiments described herein may provide a phrase detection hardware and or software component implementing a natural language processor (NLP) analysis engine for real-time phrase and disposition detection analysis. The NLP analysis engine provides a practical way to monitor a communications session while in progress on the telecommunications server platform. The NLP analysis engine triggers an external action control component to transmit control commands to external devices to trigger performance of predetermined actions based upon detected phases within voice data representing speech signals of a real-time in progress communications session (e.g. voice, video, messaging). The NLP analysis engine uses NLP techniques to non-intrusively “listen” to or otherwise monitor a live communications session. All communications transmissions will be able to be monitored in real time through a graphical user dashboard interface. This interface can detect key words, disposition, cadence and other voice data and visually display and suggest actionable insights, resource deployment and other protocols in real time or in post communications transmission historical data logs, built into the telecommunications system.

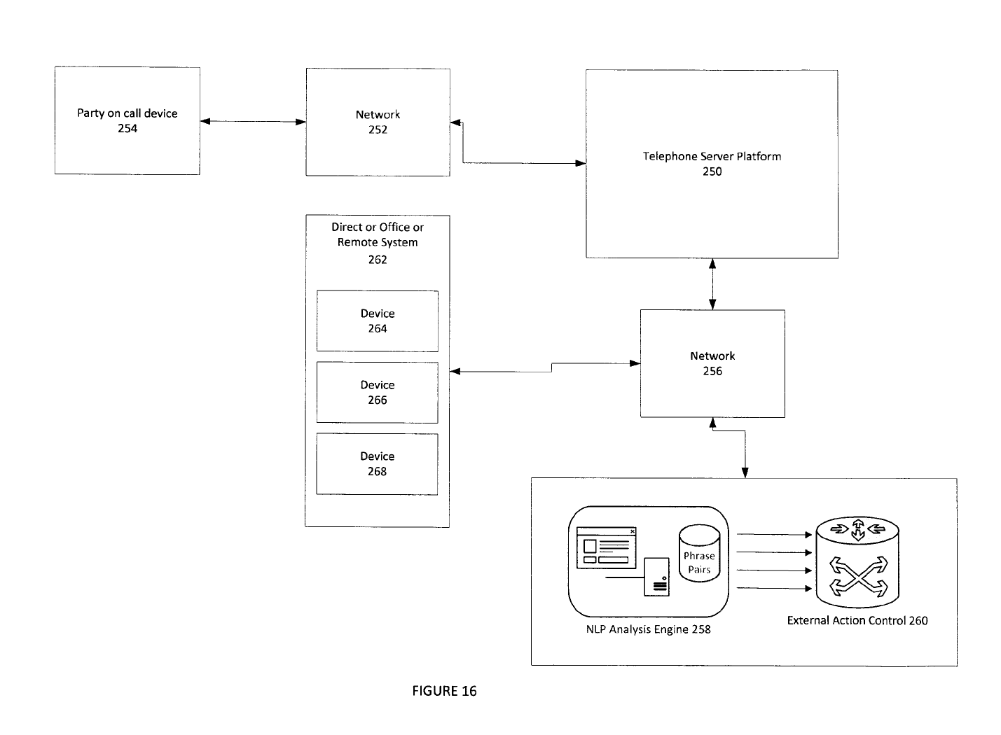

FIG. 16 illustrates a server platform 250 coupled to a hardware processor configuring NLP analysis engine 258 and external action control 260 (which is in turn coupled to one or more computing devices to transmit control commands thereto to actuate or control one or more operations of the devices). In this example, server platform 250 may be coupled to the processor configuring NLP analysis engine 258 and external action control 260 via network 256. In other example embodiments, NLP analysis engine 258 and external action control 260 may be internal components of server platform 250. Server platform 250 has a processor and memory and implements cloud based telecommunications services as described herein. For a conference communications session connection, server platform 250 connects to one or more party on call devices 254 via network 252, and server platform 250 connects to one or more devices 264, 266, 268 of direct or office or remote system 262 via network 256. Attendants or operators may operate computing devices 264, 266, 268. In some embodiments one or more computing devices 264, 266, 268 may be separate and remote from office system 262.

NLP analysis engine 258 implements a methodology to effectively “listen” to or otherwise monitor a live communication session in order to detect phrases, disposition and other actionable vocal or text based cues that are spoken or used throughout the conversation of the communication session. NLP analysis engine 258 triggers performance of predetermined actions based upon those words or phrases via external action control 260.

NLP analysis engine 258 implements proprietary algorithms to compare words and phrases against phrase pairs that are stored in a data store. A phrase is constantly and dynamically determined and analyzed using text data generated by converting speech signals of a connection (e.g. voice, video with audio) or text data of a messaging session by detecting silence to determine the ends of words and continually add to a phrase. This silence detection criteria is dynamically selectable to fine tune performance of individual languages, dialects and speech cadence patterns. Once NLP analysis engine 258 detects a match then NLP analysis engine 258 triggers external action control 260 to transmit one or more control commands to connected devices to perform a predetermined action based upon a pre-determined criteria. For example, NLP analysis engine 258 may link one or more phrase pairs stored in data store to one or more pre-determined actions, and external action control 260 is configured to generate and transmit a control command based on the linked pre-determined actions. External action control 260 controls operation of one or more devices using the control commands in response to match detection by NLP analysis engine 258. Some examples of predetermined criteria include detecting usage of profanity and or anger by agents or third party callers with an automatic transfer to a supervisor, certain Marketing trigger words to encourage cross-sell, selecting certain call center agents to handle certain callers' needs based on their language and dialect and statistically analysing call center script performance in real time or for infinite post call historical analysis.

A phrase is constantly and dynamically built in memory and analyzed using text and voice data generated by converting speech signals of a connection (e.g. voice, video with audio) or text data of a messaging session. NLP analysis engine 258 may convert speech signals into text data using a speech to text processor. NLP analysis engine 258 may then perform matching on text data (obtained from speech to text processor, or directly as text data via a messaging application for example) to detect phrases, language, intonation, cadence, timbre or disposition linked to one or more predetermined action. NLP analysis engine 258 may identify complete phrases or segment text data or voice signals into word components of the phrase. The word components may be identified by detecting silence in the speech signals to determine the end of the word. Once the end of the word is determined, it is added to the voice or text data defining the phrase for analysis. Each instance of adding a word to the phrase using silence detection in turn triggers another call to NLP analysis engine 258 for further analysis, thereby continually and dynamically analyzing the phrase. In a surveillance environment application, upon detecting words or phrases related to terrorism, a government agency can immediately be notified and take appropriate action.

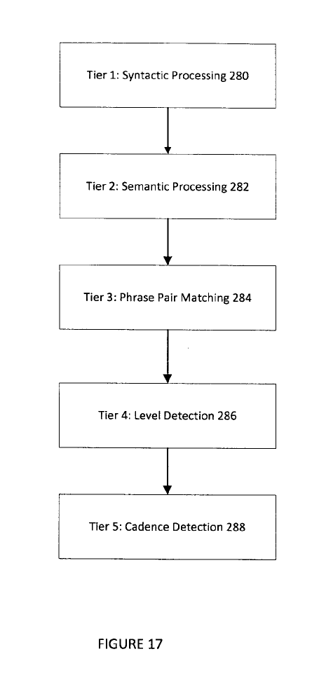

In accordance with some embodiments, NLP analysis engine 258 may implement a five tier parameter approach to detect phrases and trigger control commands. FIG. 17 illustrates a flow chart diagram of a method for the five tier parameter approach. At step 280, NLP analysis engine 258 may implement a syntactic algorithm to determine syntax for the voice or text data. This process analyzes the rules that govern the ways in which words combine to form phrases, clauses, and sentences. Syntax is one of the major components of grammar. For example, “Colorless green ideas sleep furiously.” makes grammatical sense, but is incomprehensible due to its syntax. At step 282, NLP analysis engine 258 may determine semantics, and at 284, maintain and lookup against the data store of phrase pairs. In addition, at steps 286 and 288, NLP analysis engine 258 may implement level and cadence detection to allow for the detection of volume changes in voice and cadence changes. The NLP Semantic processing examines how words have “meaning”; how words have reference (denotation) and associated concepts (connotations). For example associating the word ‘grass’ with the color green. NLP analysis engine 258 may implement syntactic level processing at 284 to predict part-of-speech tags for each word such as noun, verb and adjective etc. in a given sentence as well as the various relationships between them including subject, object and other modifiers. Phrase pair monitoring examples include phrase pair monitoring considered: (1) a head noun and its left adjective or noun adjunct, (2) a head noun and the head of its right adjunct, (3) the main verb of a clause and the head of its object phrase, and (4) the head of the subject phrase and the main verb. These types of pairs account for most of the syntactic variants for relating two words (or simple phrases) into pairs carrying compatible semantic content. For example, the pair ‘retrieve+information’ may be extracted from the following fragments: “retrieval of information from databases”. NLP analysis engine 258 may implement multilingual syntactic analysis to build robust modeling. This allows a transfer of knowledge from a resource rich language to a language that might have fewer resources.

The semantic approach at 282 addresses problems such as noun-phrase extraction by tagging noun-phrases as either person, organization, location or common noun, clustering noun-phrases that refer to the same entity both within and across data sets resolving mentions of entities in free text against entities in a knowledge base, relation and knowledge extraction.

The cadence detection report (generated at 288) on the cadence of the spoken word includes data on changes and the rate of speech for use by NLP analysis engine 258 to determine things like aggressive, anger speech, other vocal cues and so on. Level detection (at 286) is used similarly in that NLP analysis engine 258 reports volume levels and changes in the speech pattern. Level and Cadence detection can detect variance in amplitude and cadence in speech patterns to determine the disposition and emotion based on a person's tone of voice or other vocal qualities.

Prior approaches may require a human operator to manually listen to and monitor a call to perform the desired action. This may be time-consuming, inaccurate, inefficient use of human resources, increase costs, and so on. Further solutions that are not built into a given telecommunications system may require extra investments of hardware and or software.

Phrase Finder

Embodiments described herein may provide a telecommunications server platform implementing a phrase detection component for phrase analysis and detection. The phrase analysis and detection component processes voice data for voice or video mail messages, or text data for text messages for the distributed cloud based telecommunications processing environment of the telecommunications server platform.

While away from their device or occupied, a user is unable to delegate tasks or respond to certain situations in the case of a voice mail with specific information being left. Upon returning, it can be difficult to determine which communication session (e.g. voice, video, messaging) mails should be responded to in order.

The server platform detects specific words or phrases, as well as changes in “volume, pitch and tone”. This enables specific responses such as task delegation, prompts or in the case of emergency, escalation. The technology scans the mail and messages (e.g. voice, video, messaging) for a predetermined specific phrase or word and performs an action such as notifying a user or secondary user to perform an action, or trigger an action by another component.

For example, if a user is on vacation and away from their desk for the next week, they can have all of their Voice Mails scanned for certain keywords. They can specify that if the words “Saigon Project” appear in any communication such as email, text message or voice mail, an assistant should be notified immediately with further action required. In addition, a user can easily search messages for keywords and phrases.

The server platform may use a combination of any or all of the elements within the five tier parameter approach (as shown in FIG. 17). The first is a syntactic algorithm where server platform determines syntax (at 280). Then server platform determines semantics (at 282) as well maintains and lookup against a database of phrase pairs (at 284). In addition to these two processes, server platform adds level and cadence detection (at 286, 288) to allow for the detection of volume changes in a voice and cadence changes.

At the syntactic level the process predicts part-of-speech tags for each word such as noun, verb and adjective in a given sentence as well as the various relationships between them including subject, object and other modifiers. The multilingual syntactic analysis builds robust modeling. This allows a transfer of knowledge from a resource rich language to one that might have fewer resources.

The semantic approach may deal with problems such as noun-phrase extraction by tagging these noun-phrases as either person, organization, location or common noun, clustering noun-phrases that refer to the same entity both within and across data sets resolving mentions of entities in free text against entities in a knowledge base, relation and knowledge extraction.

The cadence detection report on the cadence of the spoken word to report on changes and the rate of speech so server platform can determine things like aggressive speech. Level detection is used similarly in that server platform computes report amplitude levels and changes in the speech pattern.

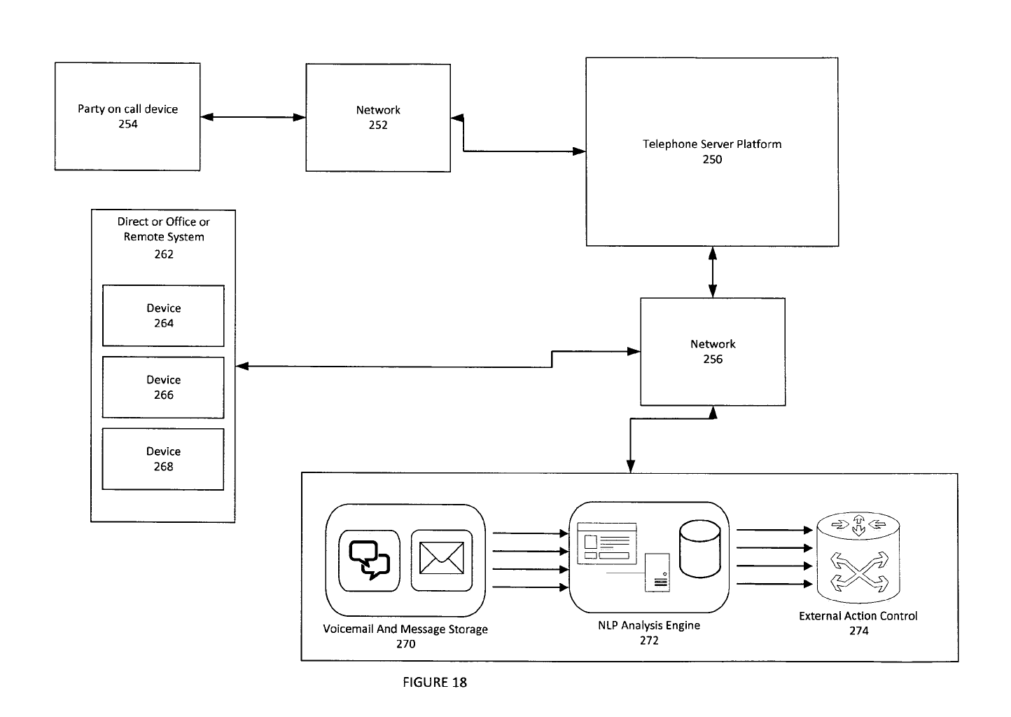

The speech pattern is reported to the External Action Controller layer, shown in FIG. 18 at 274. External Action Controller 274 determines the action to take. In addition this tool can be invoked from a menu to perform historical data and phrase analysis on a large set of historical data. External Action Controller 274 performs analytics in real time and historical data analysis.

Server platform performs these processing functions in an automated fashion. Current approaches require a user to listen to each voice mail independently in order to locate the information that they are seeking. The technology offers automation processing which trigger various external or internal actions.

Security

Embodiments described herein relate to cloud computing telecommunications systems where a telecommunications server platform implements various security features,

Secure Connect

Embodiments described herein may provide a telecommunications server platform implementing a secondary secure connection for a SIP based telecommunications device with voice, video and text data exchanged in a live communication session (e.g. in progress). The secure connection is provided in the distributed cloud based telecommunication processing environment of the telecommunications server platform.

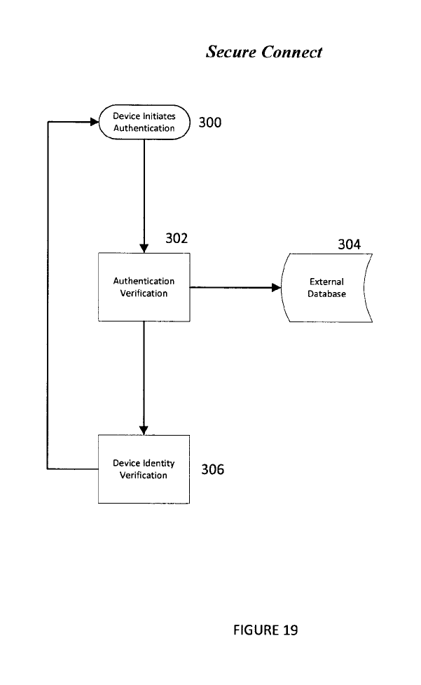

FIG. 19 illustrates a schematic diagram of a data flow for providing a secondary secure connection. At 300, the device initiates authentication via a client application, for example. At 302, the secondary secure connection or “Secure Connect” authenticates the device using data from an external store (304). At 306, the secondary secure connection or “Secure Connect” implements device identity verification as an additional authentication layer.

Management and other users may require a higher level of security and authentication of devices than what is currently available to them. Peripheral devices and soft phones are able to access PBX switches through a single layer authentication process. If someone has access to the password, they can access the PBX platform and its functionality and information.

The “Secure Connect” process provides device authentication through the two-step security process. This dual level authentication incorporates the single layer found on other devices in addition to an extra MAC verification layer authentication by the server platform. This dual authentication for devices adds another level of security that helps prevent unauthorized use of any connected device. This allows third party hardware to be used securely as peripheral devices on the system.

Secure Connect provides a secondary security level to standard SIP protocol. It uses the MAC address of the external device to do a secondary level of authentication by comparing the MAC address to a list of authorized ones in a database pre-determined by the administrator. As well, the IP address may be noted to indicate the possibility of fraud.

Known approaches use manual oversight which would require additional staffing and or effort to monitor each device connection to ensure authenticity of the client, which is impractical in a large scale environment.

Secure Connect provides enhanced security supported by a dual layer of authentication. Dual layer authentication offers greater protection over current business telephone and or telecommunications switching systems available.

Secure Scrambled Voice Mail

Embodiments described herein may provide a telecommunications server platform implementing a secure virtual machine to provide Secure Scrambled Voice Mail (SSVM) in the distributed cloud based telecommunications processing environment.

Voice Mail in a distributed environment or any environment that has an external data link such as for Internet access, is vulnerable to outside threats from internal and external hackers. Either a distributed or cloud based voice processing system or a system that may store Voice Mail locally and have access to the outside world such as via a data link. The stored Voice Mail messages are vulnerable to being compromised by an external hacker attack, or internal user data theft. Current technology does not offer file level Voice Mail encryption. Once a hacker gains access to the system they can easily download and listen to Voice Mail messages. Coupled with this is that most Voice Mail systems use standard .wav or .mp3 files which are able to be played on many devices natively, and are easy to share, propagate or download.

The server platform transforms a Voice Mail file by scrambling it using high bit rate variable key based encryption. The server platform process a Voice Mail, messaging and or other type of file by splitting the file and store the various pieces on multiple drives in various locations.

The logic contained in the slice server 314 generates the scrambling and slicing dynamically on a per session instance thereby scrambling and slicing the voice message file differently every time. The scrambling may be based upon the randomly generated key, so that the voice mail or messaging files are sliced and scrambled. Each slice may be stored in a different physical location. The location is a further level of security as a variable in the slicing and scrambling processing algorithm. This added variable provides an additional level of security. The solution provides file-level encryption for message-level protection.

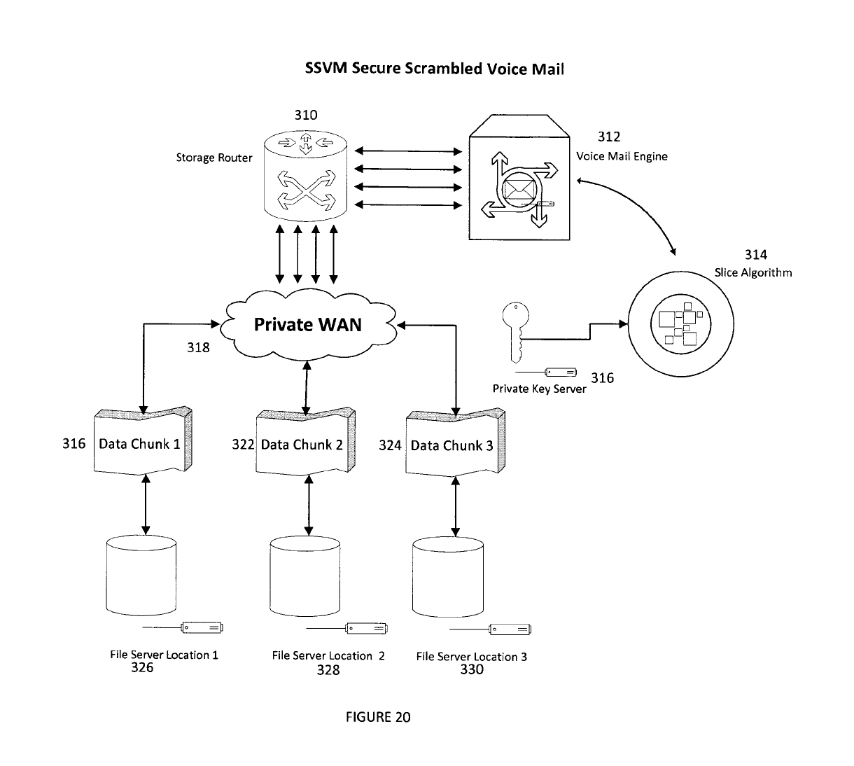

FIG. 20 illustrates a schematic for the secure voice mail system. The voice mail engine 312 interacts with storage router 310 to store and retrieve voice mail files. The slice server 314 implementing the process accesses a private key from a private key server 316. The data chunks 320, 322, 324 from the sliced and scrambled voice mail files are stored in different file server locations 326, 328,330, which connect to the storage router 310 by private network 318 in this example.

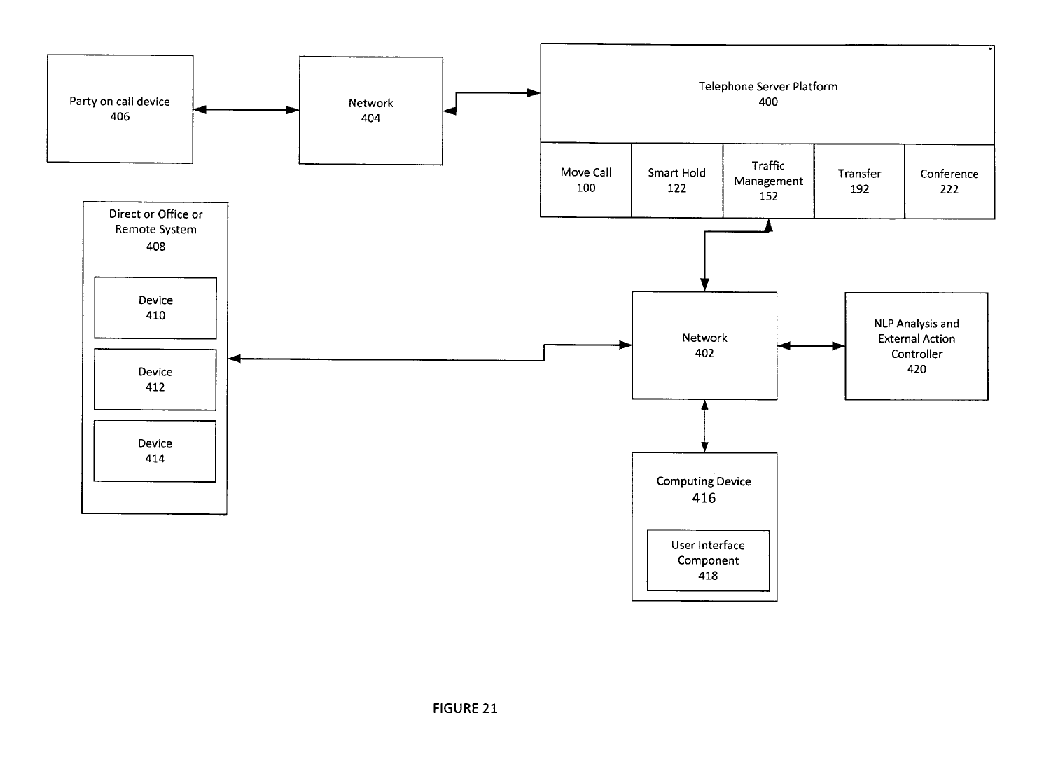

In an aspect, some embodiments may involve combinations of telecommunications services and functionality described herein. FIG. 21 illustrates an example comprehensive system involving different components working cohesively to provide an enhanced telephone server platform 400 that connects to devices 406, 416, 410, 412, 414. The enhanced telephone server platform 400 may include our couple to an NLP analysis engine with external action control 420. Some devices 410, 412, 414 may be part of a direct or office or remote system 408. A device 416 may include a user interface component 418 as described.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. A cloud based telecommunication system comprising:
(a) a telecommunications switching platform for communication session connections between a telecommunications server platform and multiple client devices;
(b) a cloud computing telecommunications switch device that connects seamlessly and in real-time to the multiple client devices of different types and formats to establish the communication session connection and data packet exchange, the data packets may be voice, video, messaging, screen broadcasting, conferencing, video/voice, and so on.

2. The cloud based telecommunication system of claim 1 further comprising:
(a) a telecommunications server platform for cloud based distributed communication session processing, the server platform interacting with the switching platform and switch device for the communication session; and
(b) a real time two-way socket data stream connection between the telecommunications server platform and the multiple client devices to establish the communication session connection and data packet exchange.

3. The cloud based telecommunication system of claim 1 further comprising:
(a) a live call communicator (LCC) interface that provides real-time communication session display monitoring and two-way interaction with a manager client device for the communication session.

4. The cloud based telecommunication system of claims 1 further comprising: a cloud based move call application that seamlessly moves a communication session connection from one device to another device without interrupting the communication session in progress.

5. The cloud based telecommunication system of claims 1 further comprising: a Smart Hold application for selection of on-hold messaging to be dynamically and automatically selected and delivered to a client device based upon communication session related data.

6. The cloud based telecommunications switching platform of claim 5 wherein the communication session related data comprises caller ID number, dialed number, preferences, session initiation protocol (SIP) address that they are calling from, or other call related data.

7. The cloud based telecommunication system of claims 1 further comprising: a traffic management application that controls routing of the communication session connection data packets over network hardware components and between devices of the communication session (voice, video, messaging) using dynamic input and routing criteria.

8. The cloud based telecommunication system of claims 1 further comprising: a network controller for the cloud based telecommunication system comprising:
(a) a processor to detect a request for a call connection between a plurality of communication session devices using a plurality geographically diverse telecommunications servers and network infrastructure, and in response, determine a distribution across the plurality of geographically diverse telecommunications servers for the call connection between the plurality of disparate devices; and
(b) routing hardware to establish a communication session connection between the plurality of disparate devices using the distribution across the plurality geographically diverse telecommunications servers.

9. The cloud based telecommunication system of claims 1 further comprising:
(a) a telecommunications server platform for cloud based distributed communication session processing; and
(b) a transfer application coupled to a graphical user interface for display on a display device, the transfer application for transferring a communication session connection to at least one other call device using the telecommunications server platform in response to detecting a transfer action at the graphical user interface.

10. The cloud based telecommunication system of claims 1 further comprising:
(a) a telecommunications server platform for cloud based distributed communication session processing; and
(b) a conference application coupled to a graphical user interface for display on a display device, the conference application for establishing a conference communication session connection between a plurality of disparate devices using the telecommunications server platform in response to detecting a single action at the graphical user interface.

11. The cloud based telecommunications system of claims 1 further comprising:
(a) a telecommunications server platform for cloud based distributed communication session processing; and
(b) a security application for securing a communication session connection to at least one other call device using the telecommunications server platform with a secondary level of authentication.

12. The cloud based telecommunications system of claims 1 further comprising:
(a) a telecommunications server platform for cloud based distributed communication session processing;
(b) a data storage server with voice mail files; and
(c) a security application for securing the voice mail files using a slicing and scrambling process.

13. The cloud based telecommunications system of claims 1 further comprising:
a telecommunications server platform for cloud based distributed communication session processing;
(b) a data storage server with voice mail files; and
(c) a NLP application for processing the voice mail files to trigger external actions.

14. The cloud based telecommunications system of claims 1 further comprising:
(a) a telecommunications server platform for cloud based distributed communication session processing; and
(b) a NLP application for processing data files for a communication session in progress to trigger external actions.

15. A cloud based telecommunications system comprising:
(a) a telecommunications switching platform for communication session connections between a telecommunications server platform and multiple client devices;
(b) a cloud computing telecommunications switch device that connects seamlessly and in real-time to multiple client devices of different types and formats to establish the communication session connection and data packet exchange, the data packets may be voice, video, messaging, screen broadcasting, conferencing, video/voice, and so on;
(c) a real time two-way socket data stream connection between the telecommunications server platform and client devices to establish the communication session connection and data packet exchange;
(d) a live call communicator (LCC) interface that provides real-time communication session display monitoring and two-way interaction with a manager client device;
(e) a cloud based move call application that seamlessly moves a communication session connection from one device to another device without interrupting the communication session in progress;
(f) a Smart Hold application for selection of on-hold messaging to be dynamically and automatically selected and delivered to a client device based upon communication session related data;
(g) a traffic management application that controls routing of communication session connection data packets over network hardware components and between communication session (voice, video, messaging) devices using dynamic input and routing criteria;
(h) a network controller for a cloud based telecommunication system comprising: a processor to detect a request for a call connection between a plurality of communication session devices using a plurality geographically diverse telecommunications servers and network infrastructure, and in response, determine a distribution across the plurality of geographically diverse telecommunications servers for the call connection between the plurality of disparate devices; and routing hardware to establish a communication session connection between the plurality of disparate devices using the distribution across the plurality geographically diverse telecommunications servers;
(i) a transfer application coupled to a graphical user interface for display on a display device, the transfer application for transferring a communication session connection to at least one other call device using the telecommunications server platform in response to detecting a transfer action at the graphical user interface;
(j) a conference application coupled to a graphical user interface for display on a display device, the conference application for establishing a conference communication session connection between a plurality of disparate devices using the telecommunications server platform in response to detecting a single action at the graphical user interface;
(k) a security application for securing a communication session connection to at least one other call device using the telecommunications server platform with a secondary level of authentication;
(l) a security application for securing the voice mail files using a slicing and scrambling process;
(m) a NLP application for processing the voice mail files to trigger external actions; and
(n) a NLP application for processing data files for a communication session in progress to trigger external actions.

16. A cloud based telecommunication system comprising:
(a) a telecommunications server platform for cloud based distributed communication session processing; and
(b) a real time two-way socket data stream connection between the telecommunications server platform and client devices to establish the communication session connection and data packet exchange.

17. The cloud based telecommunication system of claim 16 further comprising:
(a) a telecommunications server platform with a live call communicator (LCC) interface that provides real-time communication session display monitoring and two-way interaction with a manager client device.

18. The cloud based telecommunications server platform of claim 16 further comprising a cloud based move call application that seamlessly moves a communication session connection from one device to another device without interrupting the communication session in progress.

19. The cloud based telecommunications server platform of claim 16 further comprising a telecommunications switching platform configuring a Smart Hold application for selection of on-hold messaging to be dynamically and automatically selected and delivered to a client device based upon communication session related data.

20. The cloud based telecommunications server platform of claim 19 wherein the communication session related data comprises caller ID number, dialed number, preferences, session initiation protocol (SIP) address that they are calling from, or other call related data.

21. The cloud based telecommunications server platform of claims 16 further comprising a traffic management application that controls routing of communication session connection data packets over network hardware components and between communication session (voice, video, messaging) devices using dynamic input and routing criteria.

22. The cloud based telecommunications server platform of claims 16 further comprising a network controller for a cloud based telecommunication system comprising:
(a) a processor to detect a request for a call connection between a plurality of communication session devices using a plurality geographically diverse telecommunications servers and network infrastructure, and in response, determine a distribution across the plurality of geographically diverse telecommunications servers for the call connection between the plurality of disparate devices; and
(b) routing hardware to establish a communication session connection between the plurality of disparate devices using the distribution across the plurality geographically diverse telecommunications servers.

23. The cloud based telecommunications server platform of claims 16 further comprising:
(a) a transfer application coupled to a graphical user interface for display on a display device, the transfer application for transferring a communication session connection to at least one other call device using the telecommunications server platform in response to detecting a transfer action at the graphical user interface.

24. The cloud based telecommunications server platform of claims 16 further comprising:
(a) a conference application coupled to a graphical user interface for display on a display device, the conference application for establishing a conference communication session connection between a plurality of disparate devices using the telecommunications server platform in response to detecting a single action at the graphical user interface.

25. The cloud based telecommunications server platform of claims 16 further comprising:
(a) a security application for securing a communication session connection to at least one other call device using the telecommunications server platform with a secondary level of authentication.

26. The cloud based telecommunications server platform of claims 16 further comprising:
(a) a data storage server with voice mail files; and
(b) a security application for securing the voice mail files using a slicing and scrambling process.

27. The cloud based telecommunications server platform of claims 16 further comprising:
(a) a data storage server with voice mail files; and
(b) a NLP application for processing the voice mail files to trigger external actions.

28. The cloud based telecommunications server platform of claims 16 further comprising:
(a) a NLP application for processing data files for a communication session in progress to trigger external actions.

29. The cloud based telecommunications server platform of claims 16 further comprising:
(a) a telecommunications switching platform; and
(b) a cloud computing telecommunications switch device that connects seamlessly and in real-time to multiple client devices of different types and formats to establish the communication session connection and data packet exchange, the data packets may be voice, video, messaging, screen broadcasting, conferencing, video/voice, and so on.

30. A cloud based telecommunications system comprising one or more of:
(a) a telecommunications switching platform for communication session connections between a telecommunications server platform and multiple client devices;
(b) a cloud computing telecommunications switch device that connects seamlessly and in real-time to multiple client devices of different types and formats to establish the communication session connection and data packet exchange, the data packets may be voice, video, messaging, screen broadcasting, conferencing, video/voice, and so on;
(c) a real time two-way socket data stream connection between the telecommunications server platform and client devices to establish the communication session connection and data packet exchange;
(d) a live call communicator (LCC) interface that provides real-time communication session display monitoring and two-way interaction with a manager client device;
(e) a cloud based move call application that seamlessly moves a communication session connection from one device to another device without interrupting the communication session in progress;
(f) a Smart Hold application for selection of on-hold messaging to be dynamically and automatically selected and delivered to a client device based upon communication session related data;
(g) a traffic management application that controls routing of communication session connection data packets over network hardware components and between communication session (voice, video, messaging) devices using dynamic input and routing criteria;
(h) a network controller for a cloud based telecommunication system comprising: a processor to detect a request for a call connection between a plurality of communication session devices using a plurality geographically diverse telecommunications servers and network infrastructure, and in response, determine a distribution across the plurality of geographically diverse telecommunications servers for the call connection between the plurality of disparate devices; and routing hardware to establish a communication session connection between the plurality of disparate devices using the distribution across the plurality geographically diverse telecommunications servers;
(i) a transfer application coupled to a graphical user interface for display on a display device, the transfer application for transferring a communication session connection to at least one other call device using the telecommunications server platform in response to detecting a transfer action at the graphical user interface;
(j) a conference application coupled to a graphical user interface for display on a display device, the conference application for establishing a conference communication session connection between a plurality of disparate devices using the telecommunications server platform in response to detecting a single action at the graphical user interface;
(k) a security application for securing a communication session connection to at least one other call device using the telecommunications server platform with a secondary level of authentication;
(l) a security application for securing the voice mail files using a slicing and scrambling process;
(m) a NLP application for processing the voice mail files to trigger external actions; and
(n) a NLP application for processing data files for a communication session in progress to trigger external actions.
